(19) United States
(12) Patent Application Publication
(10) Pub. No.: US 2013/0225123 A1
(43) Pub. Date: Aug. 29, 2013

(54) METHOD AND APPARATUS FOR SEAMLESS DELIVERY OF SERVICES THROUGH A VIRTUALIZED NETWORK

(71) Applicant: InterDigital Patent Holdings, Inc., (US)

(72) Inventors: Pascal M. Adjakple, Great Neck, NY (US); Ulises Olvera-Hernandez, Kirkland (CA); Mahmoud Watfa, Saint Leonard (CA); Saad Ahmad, Montreal (CA); Peter S. Wang, E. Setauket, NY (US); Kai Liu, S. Huntington, NY (US)

(73) Assignee: InterDigital Patent Holdings, Inc., Wilmington, DE (US)

(21) Appl. No.: 13/779,204

(22) Filed: Feb. 27, 2013

Related U.S. Application Data
(60) Provisional application No. 61/605,009, filed on Feb. 29, 2012.

(51) Int. Cl. H04W 4/24

(52) U.S. Cl. CPC H04W 4/24
USPC 455/406

(57) ABSTRACT

Methods and apparatus for using a virtual currency module (VCM) to access service networks are described. The VCM may access the service network without the use of a UICC linked to an MNO. Virtual currency may be used to validate subscriber credentials without needing to be linked to a particular MNO. Dynamic subscription assignment may be performed upon registration and validation of credentials with a financial institution. Financial institutions may be used to support and validate virtual currency. Menus may be provided to allow a user to select specific services while accessing the service networks.

### CROSS REFERENCE TO RELATED APPLICATIONS

This application claims the benefit of U.S. Provisional Application No. 61/605,009 filed Feb. 29, 2012, the content of which is hereby incorporated by reference herein.

### BACKGROUND

There are two fundamental models that prevail in offering of services that are delivered through both fixed and mobile networks. The first model is operator-specific access, where network access is tied to a specific network operator either through a subscription-based scheme or a pre-paid-based scheme. In a subscription-based scheme, a user may hold a subscription to an Internet Service Provider (ISP) or hold a subscription to a Mobile Network Operator (MNO)/Public Mobile Land Network (PLMN). In a pre-paid-based scheme, a user may buy credit that may be used to access services provided, by a MNO and/or an ISP. The second model is an operator-independent service delivery, where services are provided independently from the MNO, through multiple service providers. The service providers may be, for example, (1) social networking sites such as Facebook® and Twitter®; (2) mail services, such as Google® Mail and Yahoo® Mail; and (3) stock quoting services, weather services, user equipment (UE)-based location services, such as location services provided by Android-based devices.

Under these models the user is forced to enter into a service contract or pay for services that may never be received or that may never be used. In the pre-paid service model, users are purchasing freedom from committing to a services contract in exchange for the upfront expense of pre-paying for services. Furthermore, pre-paid services still require that the end-user purchase a Universal Integrated Circuit Card (UICC) loaded with subscription applications such as a Subscriber Identity Module (SIM) or Universal SIM (USIM) that provides the user authentication credentials and an identity to access the network. These also tie the user to the network provider that issues the UICC. Finally, pre-paid credits are often subjected to an expiration date leading to subscribers losing money as unused credit eventually expires.

Further, because there are a large amount of services decoupled from the MNO such as over-the-top services including Skype voice services, the user is never guaranteed that a particular service will necessarily run on a particular MNO. These decoupled services also pose a problem for MNOs because they often clutter their networks with additional traffic.

Regardless of the service models described above, the user is tied to a MNO, thereby limiting the user's ability to freely choose services or only pay for the consumed service at the time the service is consumed. Despite the move by many MNOs toward a network-sharing model to save on network deployment and operation costs, users are still tied to a subscription or contract.

### SUMMARY

Methods and apparatus for using a virtual currency module (VCM) to access service networks are described. The VCM may access the service network without the use of a UICC linked to an MNO. Virtual currency may be used to validate subscriber credentials without needing to be linked to a particular MNO. Dynamic subscription assignment may be performed upon registration and validation of credentials with a financial institution. Financial institutions may be used to support and validate virtual currency. Menus may be provided to allow a user to select specific services while accessing the service networks.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2A is a system diagram of a service paradigm without network sharing;

FIG. 2B is a system diagram of a service paradigm with radio access network sharing;

FIG. 2C is a system diagram of a service paradigm with radio access network sharing as well as core network sharing;

FIG. 2D is a system diagram of an example of two operators sharing a Universal Terrestrial Radio Access Network (UTRAN);

FIG. 3A is a system diagram of an example of a Gateway Core Network (GWCN) configuration for network sharing;

FIG. 3B is a system diagram of an example of a Multi-Operator Core Network (MOCN) in which multiple Core Network (CN) nodes are connected to the same Radio Network Controller (RNC);

FIG. 4A is a system diagram of an example of a multi operator access system wherein operators maintain independent networks with an independent services' ecosystem;

FIG. 4B is a system diagram of an example of a multi operator access system wherein operators maintain a shared Radio Access Network (RAN) with an independent services' ecosystem and independent core networks;

FIG. 4C is a system diagram of an example of a multi operator access system wherein operators share both the RAN and the CN but include an independent services' ecosystem;

FIG. 4D is a system diagram of an example of a multi operator access system wherein the RAN, the CN, the operators, and the services' ecosystem are virtualized in an internet cloud;

FIG. 5 is a signal flow diagram of a multi operator access system;

FIG. 6A shows an example of a credit-card based subscription;

FIG. 6B is an example signal flow diagram in a credit-card based system;

FIG. 7A shows an example of a pre-paid, generic subscription system;

FIG. 7B is an example signal flow diagram of a pre-paid, generic subscription system;

FIG. 8A shows an example of a surrogate MNO system;

FIG. 8B is an example signal flow diagram of a surrogate MNO system;

FIG. 9A shows an example of multi-operator services with third-party authentication system;

FIG. 9B is an example signal flow diagram of multi-operator services with third party authentication system;

FIG. 10A shows an example of a home network assist subscription system;

FIG. 10B is an example signal flow diagram of a home network assist subscription system;

FIG. 11A shows an example network architecture with a universal PLMN system;

FIG. 11B is an example signal flow diagram of network discovery and registration in a universal PLMN system;

FIG. 12 shows an example of an authentication procedure;

FIG. 13 shows an example of user plane authentication;

FIG. 14 shows an example of home network-assisted authentication;

FIG. 15A is an example signal flow diagram of paging of a WTRU on behalf of a MNO; and

FIG. 15B is an example signal flow diagram of a WTRU monitoring paging while in idle mode.

### DETAILED DESCRIPTION

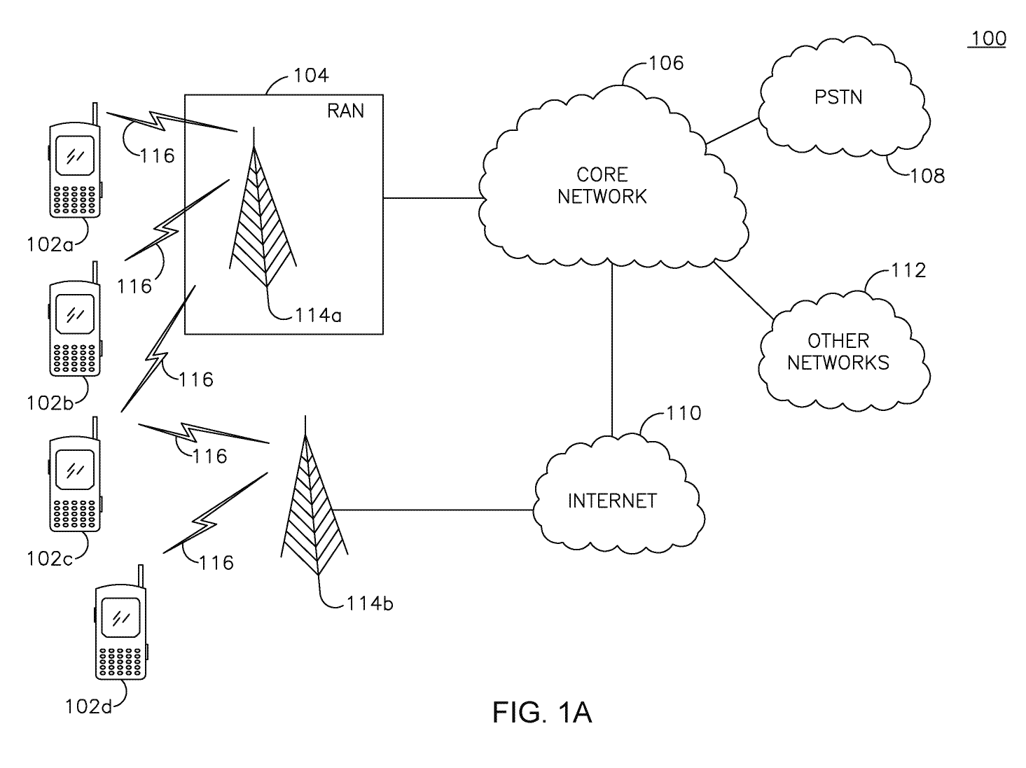

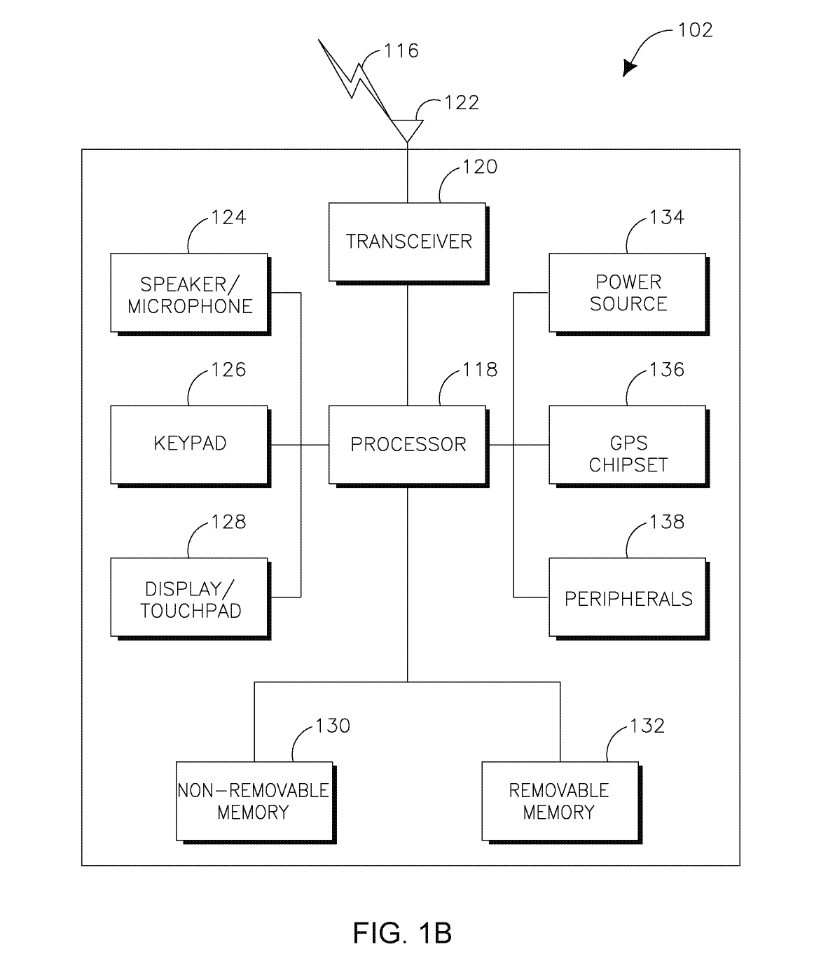

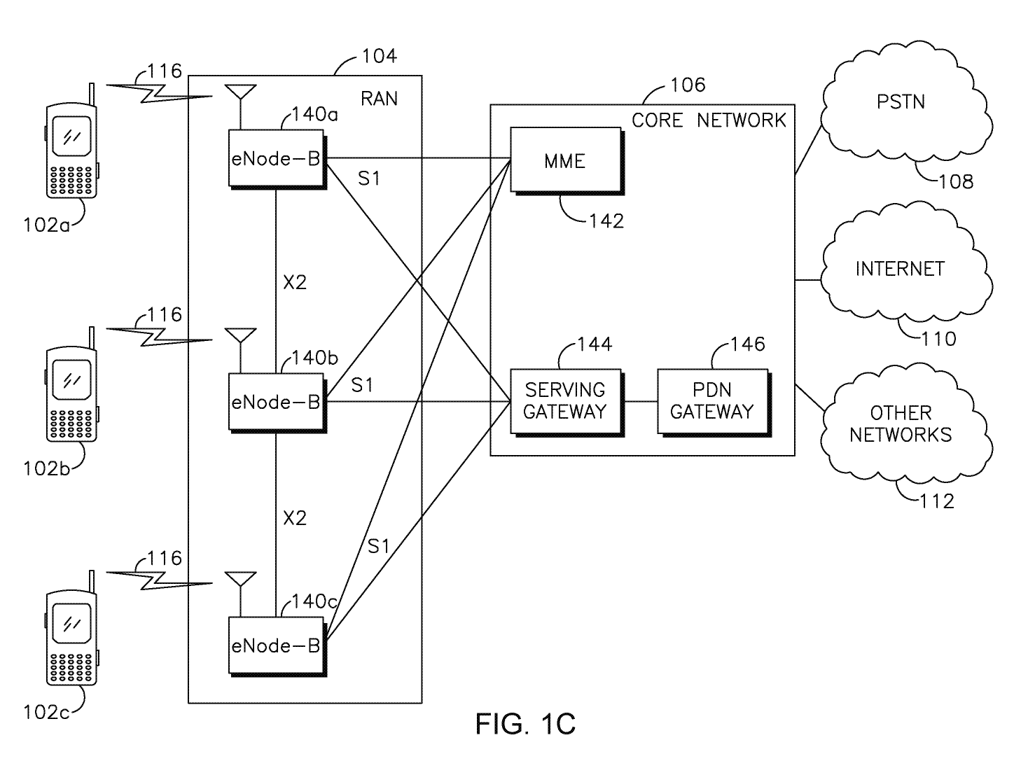

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

The various embodiments described herein utilize multi operator (or operator agnostic) system access whereby a user may discover networks, and then access any chosen network without a prior contract agreement or subscription. The user may then request services through the chosen network and have their financial credentials validated for the network. While the embodiments described hereinafter often include two network operators, this architecture may include any number of operators.

The terms Multi Operator Device (MOD) and Operator Agnostic Device (OAD) may be used interchangeably. The term financial institution may be used to designate any entity that may guarantee or provide the ability for end users to pay for a service.

The terms “multi operator access,” “service based operation,” “service based,” “service based access”, “operator agnostic access”, or “operator virtualization” may be used interchangeably. These terms all identify a mode of operation wherein a WTRU may obtain services on the fly from one or more networks (e.g. Public Land Mobile Network (PLMN)), each of which may belong to different operators and may be managed independently or jointly by said operators. The WTRU may obtain these services without any prior subscription, service contract or service agreement with the network operator. The term mobile network (e.g. PLMN) may refer to an extension of networks including but not limited to the Integrated Services Digital Network (ISDN)/Public Switched Telephone Network (PSTN), corporate and public Packet Data Networks (PDN), or the public internet. The term mobile network may also refer to a collection of mobile switching center (MSC) areas in a circuit switched (CS) domain, serving GPRS support node (SGSN) areas for general packet radio service (GPRS), or SGSN or mobility management entity (MME) areas for the evolved packet core (EPC) in packet switched (PS) domain within a common numbering plan (e.g. same National Destination Code) and a common routing plan, which are logically divided between the core network (CN) and Access Network (AN). The term mobile network operator (MNO) may refer to an administrative entity or a recognized private (or public) operating agency with a mandate to operate the network and provide mobile telecommunications services to the public.

Network sharing may refer to but is not limited to the following scenarios: multiple core networks sharing a common RAN; geographically split network sharing; network sharing over a common geographical area; common spectrum network sharing; or multiple RANs sharing a common CN.

“Virtualization” refers to a set of techniques for making a given physical resource such as a machine or network appear as multiple logical resources. Multiple users may have access to the same underlying physical resource simultaneously, but the users may be completely unaware that they are sharing the network. Virtualization may be used to describe services such as cloud services, on-demand computing, server load balancing, and the like. Internet cloud computing is a prominent example of virtualization leading to the emergence of virtual network operators or operators that do not own a physical network infrastructure and virtual service providers. A new group of operators or service providers specialize in the delivery of Infrastructure as a Service (IaaS), Platform as a Service (PaaS), or Software as a Service (SaaS).

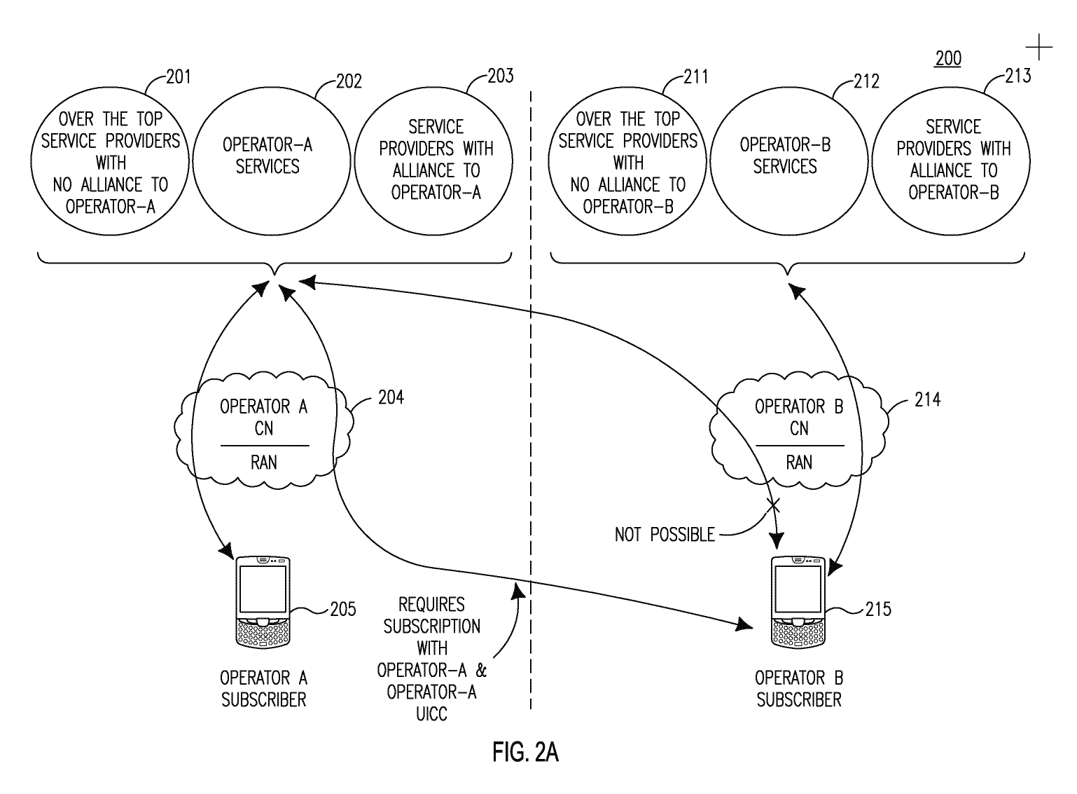

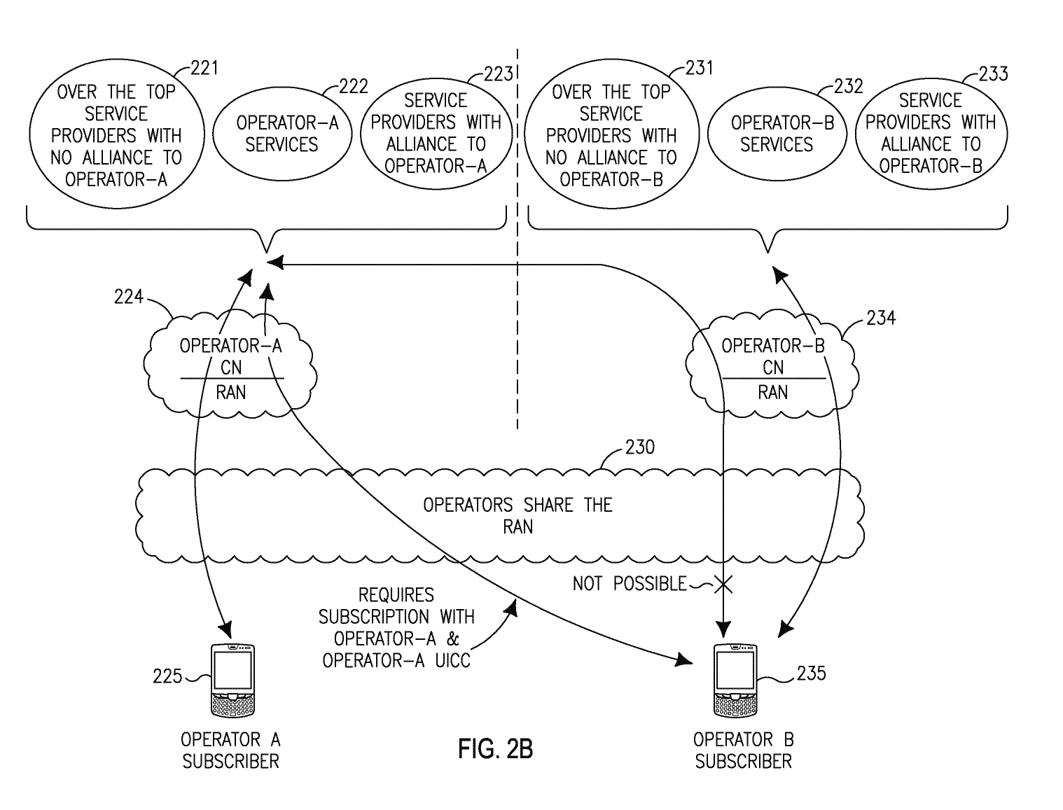

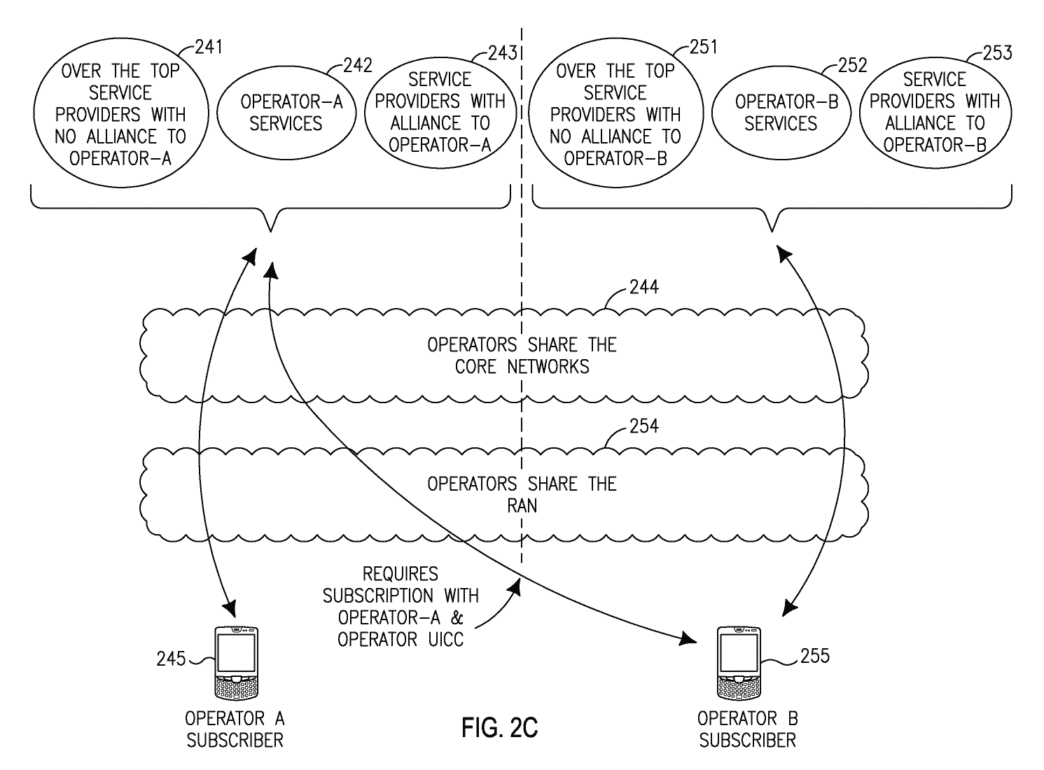

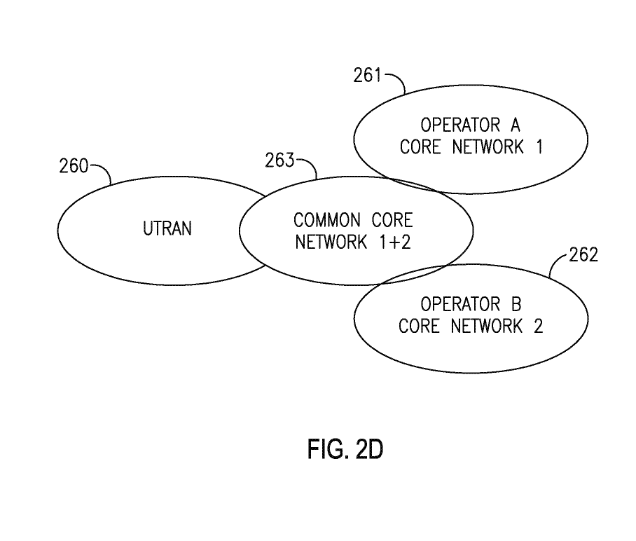

FIGS. 2A, 2B, and 2C illustrate examples of service delivery architecture whereby users are locked into an agreement with a given MNO regardless of the level of network sharing and the accessibility of services to the user.

FIG. 2A shows a service delivery architecture without network sharing 200. The MNOs 204 and 214 maintain independent core networks (CN) and RANs with independent services. WTRU 205 can only access services hosted by the MNO 204, which includes services provided by a service provider (SP) 201 with no alliance with the MNO 204, services provided by the SP 202, which is in this case the MNO 204 itself, and services provided by SPs 203 (other third parties) with alliances with the MNO 204. Likewise, WTRU 215 can only access services hosted by the MNO 214, which includes services provided by an SP 211 with no alliance with the MNO 214, services provided by the SP 212, which is in this case the MNO 214 itself, and services provided by SPs 213 (other third parties) with alliances with the MNO 214.

FIG. 2B shows an example service delivery architecture with radio access network sharing but limited sharing of services. MNO 224 and 234 maintain a shared RAN 230 with independent services. MNO 224 provides access to services offered by SPs 221 that have no alliance with the MNO 224, services provided by the SP 222 which is in this case the MNO 224 itself, and services provided by SPs 223 (other third parties) with alliances with the MNO 224. Similarly, MNO 234 provides access to services offered by SPs 231 that have no alliance with the MNO 234, services provided by the SP 232, which is in this case the MNO 234 itself, and services provided by SPs 233 (other third parties) with alliances with the MNO 234. The WTRU 235 may use the shared RAN 230 to access MNO 224 and receive services through MNO 224 on the condition that the WTRU 235 has subscription with the MNO 224 and is equipped with a UICC loaded with a SIM or USIM or the like provided by the MNO 224. However, access is denied when WTRU 235 attempts to access the services provided by MNO 224 through MNO 234.

FIG. 2C shows a service paradigm with radio access network sharing as well as core network sharing. The MNOs maintain a shared RAN 254 and a core network 244. The MNOs, however, maintain separate service domains and with no shared control over their respective hosted service domains. As a result, WTRU 255 may access the specific set of services offered or allowed by any particular MNO participating in the CN and RAN sharing agreement, on the condition that the WTRU 245 has a subscription with that particular MNO and is equipped with a UICC loaded with a SIM/USIM or the like provided by that MNO. For example, the WTRU 255 who is a subscriber of one MNO may access the services of the SPs with no alliance with the MNO 241, or the services of SPs with an alliance with the MNO 243, or services of the MNO itself 242 on the condition that the WTRU 255 has a subscription with that MNO and is equipped with a UICC loaded with a SIM/USIM or the like provided by that MNO. Similarly, the WTRU 245 who is a subscriber of another MNO may access the services of the SPs with no alliance with the MNO 251, services of the SPs with an alliance with the MNO 253, or services of the MNO itself 242 on the condition that the WTRU 245 has subscription with that MNO and is equipped with a UICC loaded with a SIM/USIM or the like provided by that MNO.

In many core network sharing architectures, however, there may be entities that are not shared. Examples of such entities include but are not limited to the Policy and Charging Rules Function (PCRF), the Home Subscriber Server (HSS), which includes the Home Location Register (HLR) and the Authentication Center (AuC), and the Equipment Identity Register (EIR).

As a complement to network sharing, the MNOs may use various APIs to expose useful network information, features, and capabilities over HTTP to web application developers. With the standardization of these APIs, the users may access network capabilities and information, regardless of the MNO via web applications.

Multi-SIM card Standby Terminals may also be used. Triple-SIM and Dual SIM mobile phones hold two or more SIM cards or utilize Dual-SIM adapters. Dual-SIM and Triple-SIM operation may allow the use of two services without the need to carry two phones at the same time. For example, the same handset may be used for business and private use with separate numbers and bills. When traveling an additional SIM may be used for each country visited. Using multiple SIM cards may allow the user to take advantage of different pricing plans for calls and text messages as well as mobile data usage. Mobile phones with built-in simultaneous dual SIM capability allow both SIMs to be active simultaneously and allow calls to be received on either number at any given time. Most such phones have two transceivers built-in, one of which may support for example, 2G and 3G while another may only support 2G. Dual SIM Phones, referred to as “Dual SIM Dual Standby” (DSDS), may provide the ability to have two active SIMs simultaneously, using only one transceiver.

The enhancements to network access and sharing technologies described above may address some of the needs of MNOs for increased flexibility in the delivery of data services to different WTRUs. These data services may be hosted by the MNOs in their data centers within a 3GPP domain or may be hosted by third party data application providers that may be outside of the MNO domain. Current practices involve individual mobile operators negotiating agreements with data application providers. These agreements may lead to proprietary additional functionality in 3GPP networks which may result in non-standard 3GPP interfaces. With the advent of service delivery mechanisms such as cloud computing and Application Stores, it may be important that the MNOs minimize upgrades to their networks and the associated backend integration. The MNO may have the opportunity to explore additional payment models as well with data service providers when sharing network resources. Sample services and/or capabilities that MNOs may provide to data application providers may include, for example, customized billing/charging, promotional services, group addressing capabilities, identity services, statistics, location services, voice services, and the like.

FIG. 2D shows an example of a public land mobile network (PLMN) sharing feature in an early 3GPP release. MNO 261 and MNO 262 may share a UTRAN 260 via a common CN 263. Sharing networks and network infrastructure in 3GPP systems may allow MNOs to also share the heavy deployment costs, especially in a roll-out phase. The selection of network-sharing scheme may depend on MNO strategy as well as on rules and legislation the MNO's region.

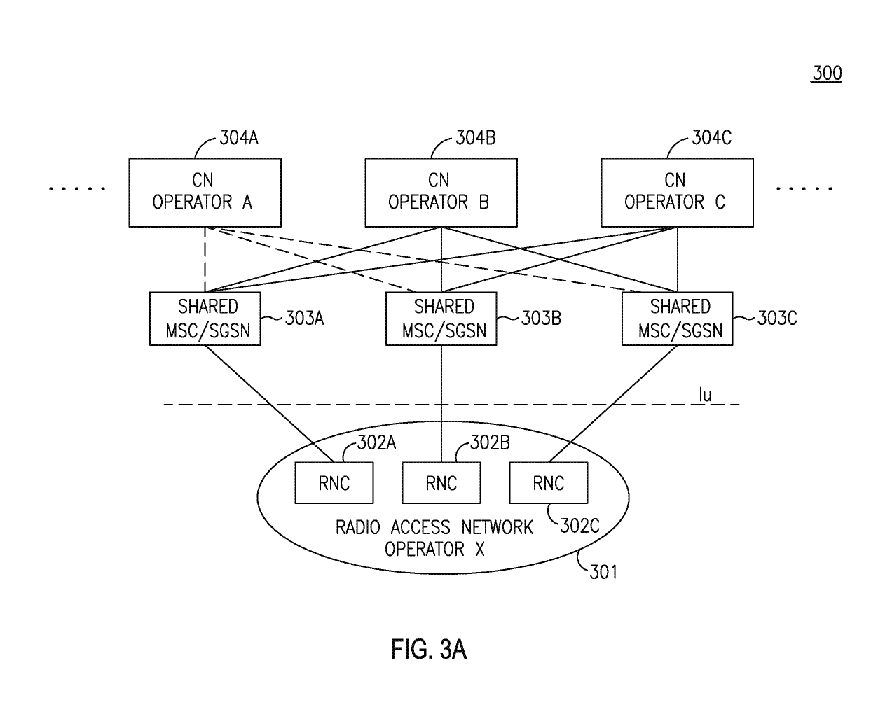

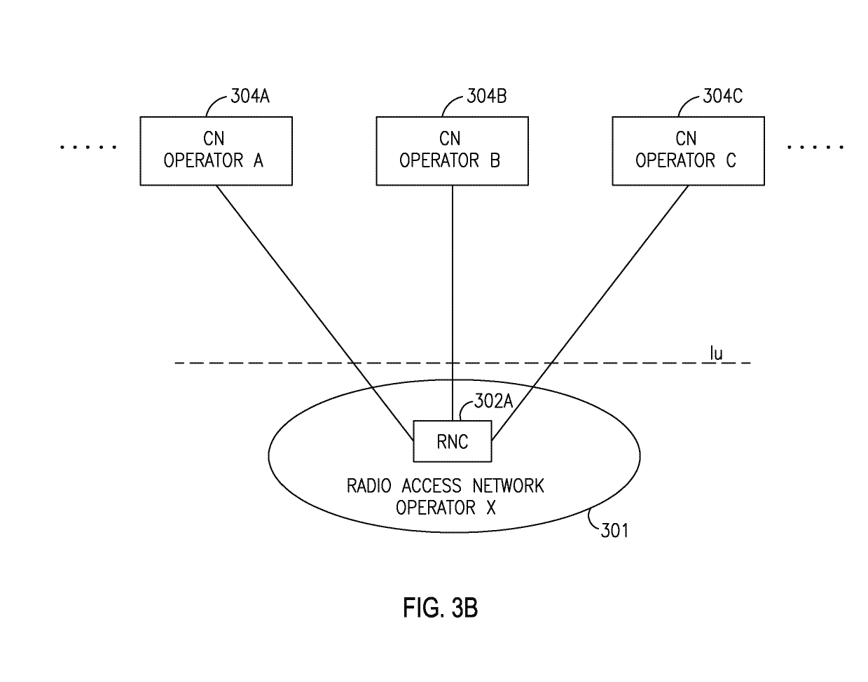

FIGS. 3A and 3B show example architectures supporting network sharing. FIG. 3A shows an example of a Gateway Core Network (GWCN) configuration for network sharing. In addition to shared RNCs 302a, 302b, and 302c, the core network operators 304a, 304b, 304c may also share core network nodes 303a, 303b, and 303c.

FIG. 3B shows an example of a Multi-Operator Core Network (MOCN) in which multiple CN nodes 304a, 304b, and 304c are connected to the same RNC 302a. The CN nodes may be operated by different MNOs 301. For the Evolved Packet System, the PS domain of FIGS. 3A and 3B may be relevant. For E-UTRAN access, both FIGS. 3A and 3B may apply, whereby the MME may replace the SGSNs 303a, 303b, and 303c, the eNodeB may replace the RNCs 302a, 302b, and 302c, and the 51 reference point may replace the Iu interface.

Despite advances in network sharing schemes as described in the example architectures above, MNOs have managed to maintain control over users because all of the examples above assume a user is locked into a subscription with a particular MNO. Developments in mobile cloud computing and network sharing may enable a service delivery method wherein the user chooses the desired services on an on-demand basis from any MNO which meets the user's selection criteria, regardless of whether the user has a traditional cellular subscription.

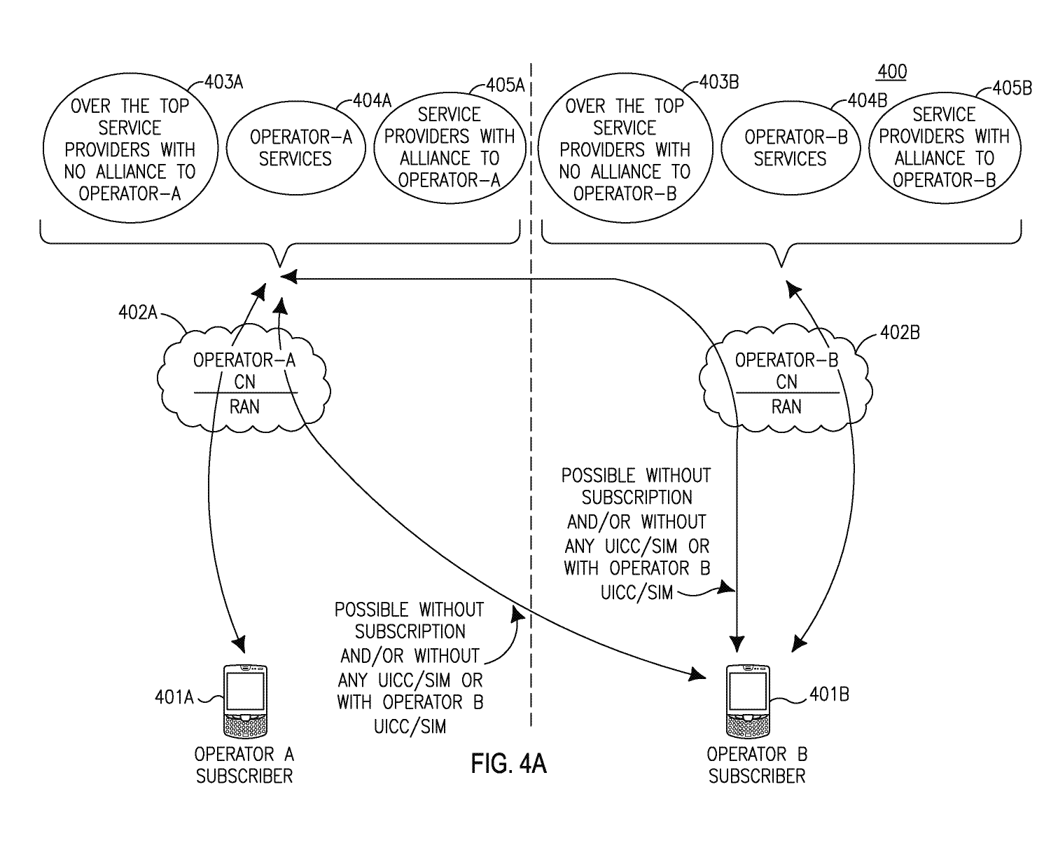

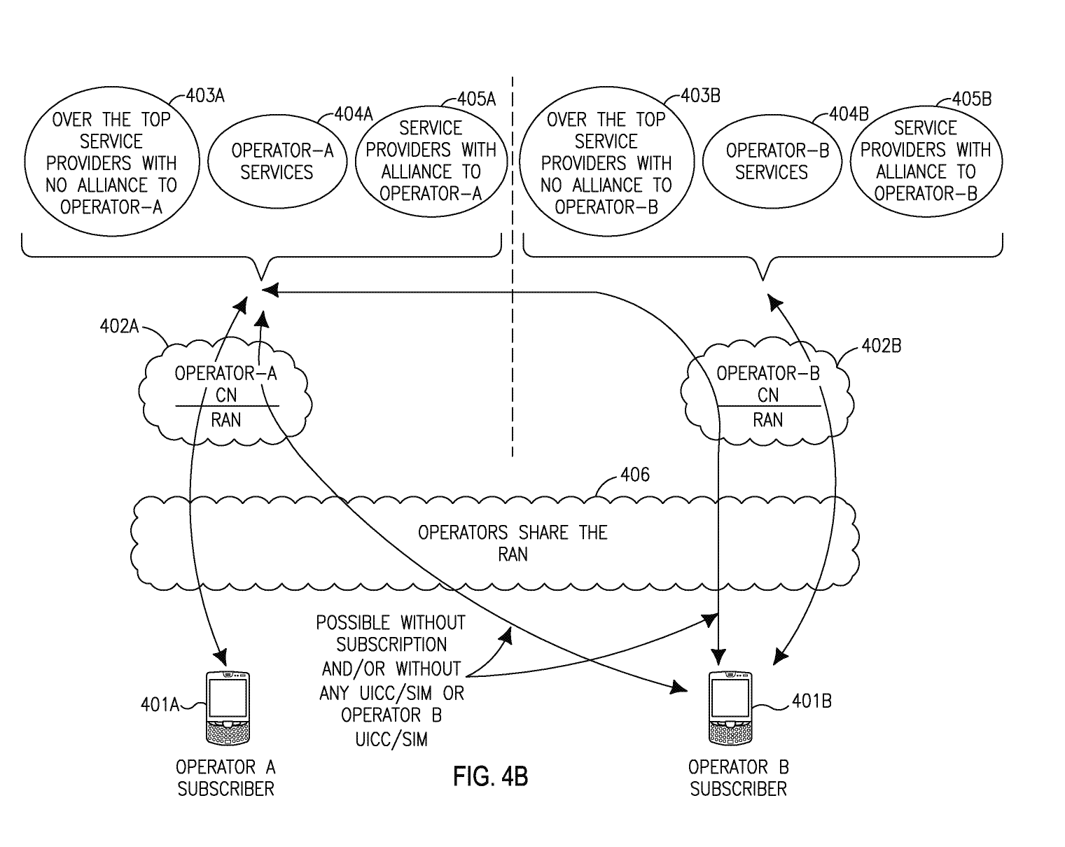

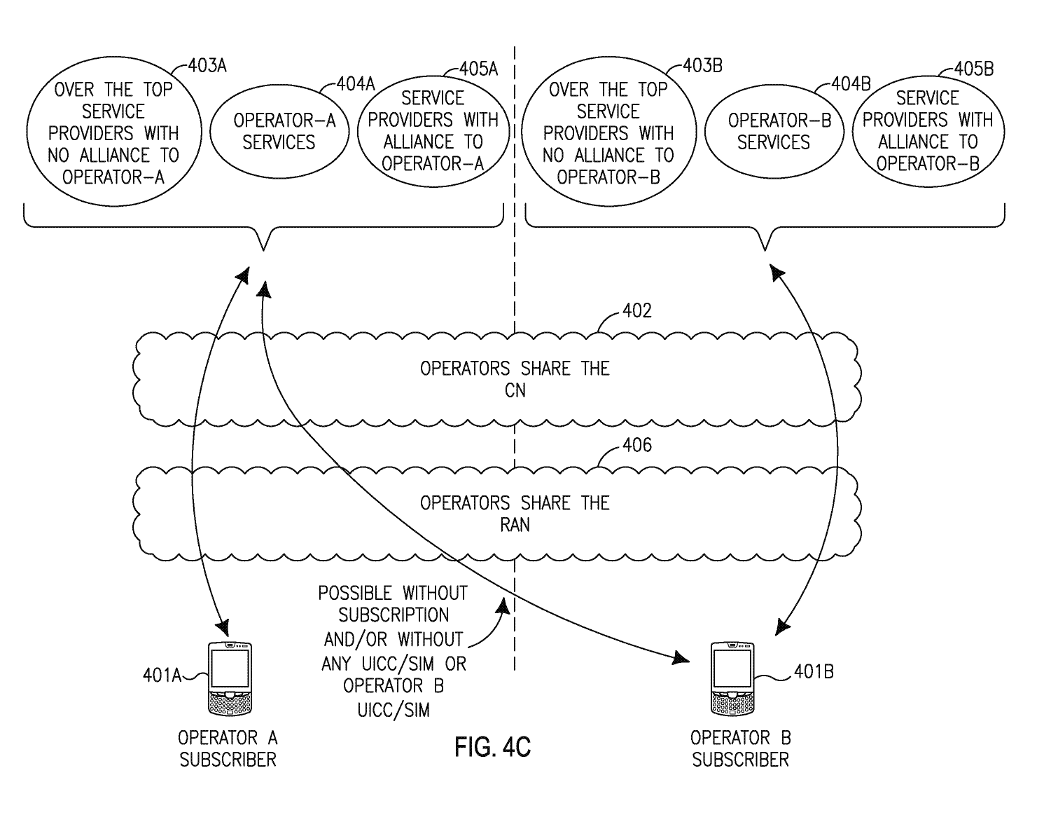

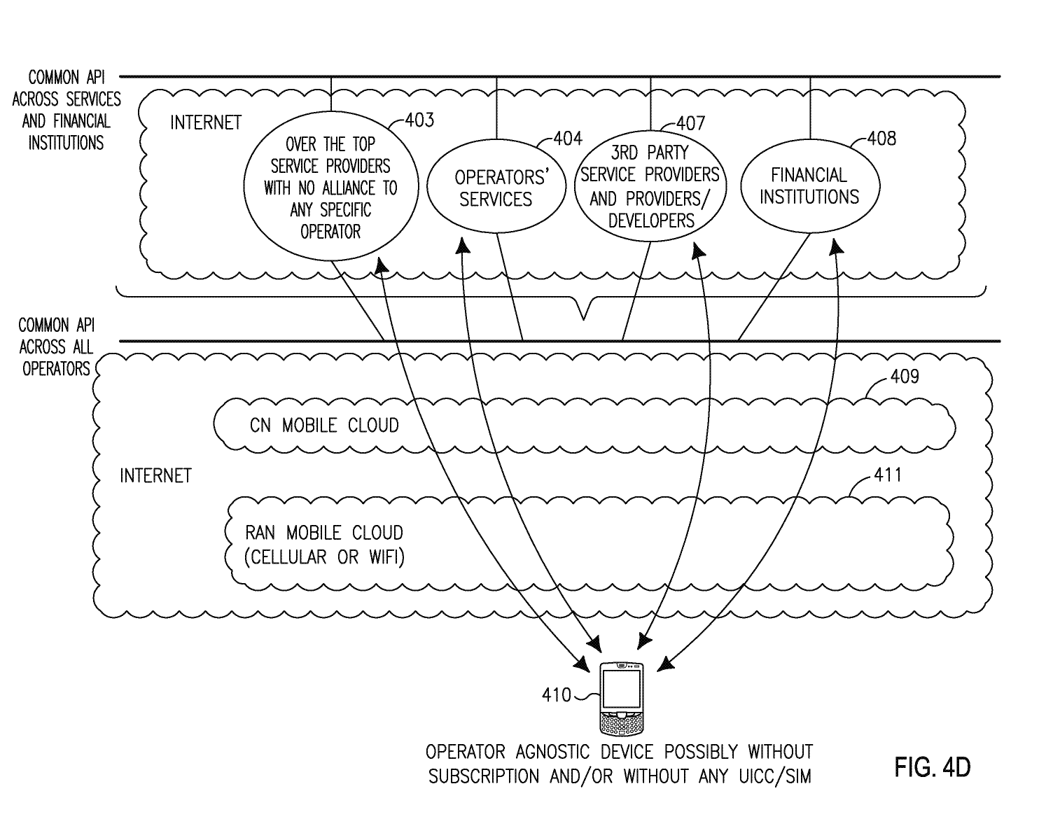

FIGS. 4A-4D show WTRUs 401a and 401b operating as Multi Operator Devices (MOD) that may access any mobile network of any Mobile Network Operator (MNO) 402a or 402b that may provide the services desired by the WTRUs 401a and 401b thereby virtualizing the network operator. The MOD may also be referred to as an Operator Agnostic Device (OAD). The WTRUs 401a and 401b may be able to access either MNO 402a or 402b with or without a prior subscription, a prior service level agreement (SLA), or without roaming agreement between the MNOs when operating as MODs. A MOD WTRU device may also support multiple MNOs with one SIM. For example, the WTRU may be able to download a user profile for multiple MNOs onto a single SIM.

As a MOD, the WTRUs 401a and 401b may be able to seamlessly operate on multiple MNOs 402a or 402b either transparently or non-transparently to the user, while ensuring a consistent user experience. Operation can be either: (1) sequential, accessing services from one MNO at a time, or (2) simultaneous, accessing services from one or more MNOs at the same time. The MOD device may perform the service-purchase activities to acquire the access rights to local networks. For example, the MOD may purchase services from the visited MNO through a user interface screen. The purchased service agreement may then grant the local network access rights, including but not limited to access barring categories, access delay properties, scheduling priorities, and QoS assignments. The purchase may be enabled by a financial institution, through the MNO's service bulletins, or through the service network coordination.

The MNOs 402a or 402b may form a pool of services that they collectively offer and send to MODs. The WTRUs 401a and 401b operating as MODs may receive information about the available services upon initial registration with one of the MNOs in the pool. The WTRUs may then receive a list of all the available services on their user interface. Additionally, WTRUs 401a and 401b acting as the MODs may receive information regarding the availability of services particular to a MNO. Moreover, the list of available services presented on the user interface may be based on the user's capacity to demonstrate financial and integrity credentials. For example, the user interface may only list services that the user's financial institution would authorize based on the user's established credit. The user may choose one or more services and may be charged based on the service selected and the charging model corresponding to the service. If the user is using services from more than one MNO simultaneously, it also may need to establish more than one PDN connection, in which one or more through PDN connection is through each of the MNO networks.

Alternatively or additionally, the MOD WTRUs 401a and 401b may receive information about the services offered by an MNO from a broadcasted RRC message. The WTRU may combine the list of available services and prices received from different MNOs and present it to the user interface. As a WTRU moves through various MNOs, the WTRU may identify the services offered by these MNOs and alert the end user using a variety of methods, including but not limited to enabling or modifying icons on the WTRU screen, playing an audible sound or sequence, or vibrating with a specific pattern or sequence.

Alternatively or additionally, the MOD WTRUs 401a and 401b may receive information about the services offered by an MNO 402a or 402b through System Information or through a dedicated NAS or RRC acknowledgement towards the WTRU. If dedicated signaling is used, the MNO may supply the WTRU with the availability of services after having verified the WTRU's credentials. The MNO may provide information about single services or groups of services, by simply supplying a bit map or an index.

The WTRUs 401a and 401b may also include multi RAT operation such as UTRAN on one MNO 402a and E-UTRAN on the other MNO 402b. The WTRUs 401a and 401b may also obtain different services from different MNOs. For example WTRU 401a may obtain SMS service from MNO 402a and voice service from MNO 402b.

The WTRUs 401a and 401b may be equipped with one or more set of radio front-ends and baseband chains. Furthermore, the WTRUs 401a and 401b may be SIM-less or UICC-less or have their SIMs virtualized.

Specifically, FIG. 4A shows an example of a multi operator system 400 wherein MNO 402a and 402b maintain independent core networks (CN) and RANs with independent services. Services provided by the MNOs 402a and 402b to WTRUs 401a and 401b include services with no alliance with the MNO 403a and 403b, services provided by the MNO 404a and 404b, and services provided by third parties with alliances with the MNO 405a and 405b. These services may be pooled by each MNO 402a and 402b and then sent to the WTRUs 401a and 401b.

FIG. 4B shows an example of a multi operator system 400 wherein MNO 402a and 402b maintain a shared RAN 406 with independent services. Services delivered through the MNOs 402a and 402b include services offered by SPs 403a and 403b that have no alliance with the MNOs 402a or 402b, services provided by SPs 404a and 404b which in this case are respectively the MNO 402a and 402b themselves, and services provided by SP 405a and 405b (other third parties) with alliances with the MNO 405a or 405b. These services may be pooled by each MNO 402a and 402b and then sent to the WTRUs 401a and 401b.

FIG. 4C shows an example of a multi operator system 400 wherein MNO 402a and 402b share both the CN 402 and the RAN 406 but include independent services. Services provided by the MNOs include services offered by SPs 403a and 403b that have no alliance with the MNOs, services provided by SPs 404a and 404b which in this case are also the MNOs participating in the network sharing agreement, and services provided by SPs 405a and 405b (other third parties) with alliances with the MNOs.

FIG. 4D shows an example of multi operator access wherein the CN 409 and the RAN 411 are virtualized in an internet cloud. The MOD (or Operator Agnostic Device) 410 can access the MNOs' services 404, services offered by the over-the-top SPs 403 with no direct alliance to any MNO, services provided by third party service and application providers 407, and services provided by their financial institutions 408 via the mobile cloud.

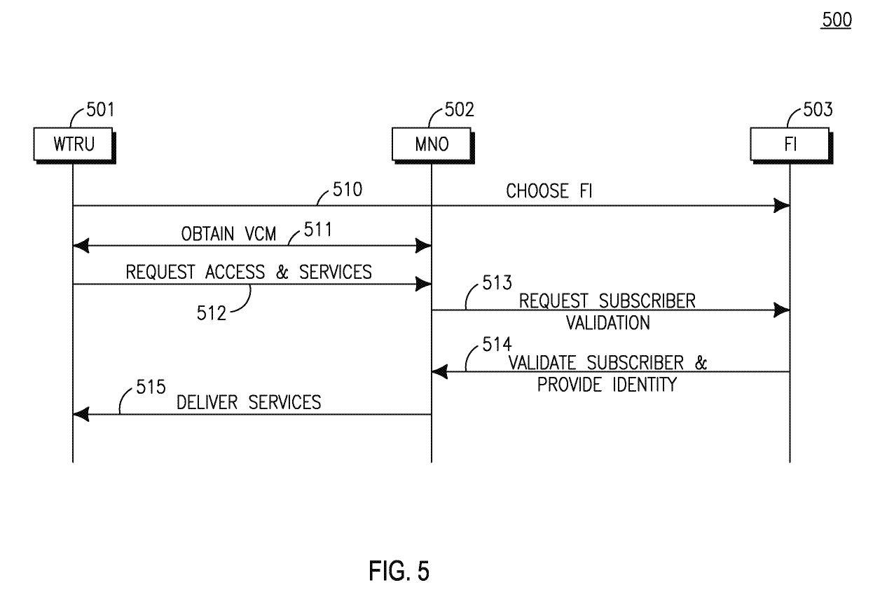

FIG. 5 shows an example signal flow diagram of a multi operator (or operator agnostic) system 500. The WTRU user 501 first establishes credit with a financial institution (FI) of the WTRU's choice 510. The WTRU 501 then obtains a virtual currency module (VCM) 511, which may be physically inserted or implemented in software in the MOD WTRU 501 and is capable of supplying financial credentials to a prospective MNO 502. The VCM is used by the WTRU 501 to prove its financial credentials and allow the WTRU 501 to operate as a MOD as described above. The VCM may be obtained from the MNO and be supported by the financial institution of the user's choice. Alternatively, the VCM may be obtained from some other provider including but not limited to the WTRU's manufacturer or the user's financial institution. The VCM may operate in UICC mode or UICC-less mode. The VCM may be enabled through a user specific signature to prevent unauthorized use; the user may enter such signature using a variety of inputs including but not limited to a voice command, a keyboard stroke sequence, a hand gesture on the WTRU 501 screen, a finger print readout, an iris readout or by using a separate credit card and swipe it, insert it or place it in proximity to the WTRU 501.

The VCM may then be used to gain mobile network access when the WTRU user 501 requests access and services 512 from a MNO 502 by providing financial credentials to the MNO 502. The MNO 502 may request subscriber validation 513 from the FI 503 by supplying the FI the credentials provided by the VCM. The FI 503 may then validate the subscriber credentials that were provided to the MNO by the VCM and provide a subscriber identity 514 to the MNO 502. The MNO 502 may decide to provide access to a set of services, all services, or no services based on the response from the FI. The services requested by the WTRU user 501 may be services from SPs with an alliance with the MNO 502, or services from SPs without an alliance with the MNO 502, or services offered directly by the MNO 502 itself. The MNO may use the subscriber identity provided by the FI 503 to address the subscriber for the delivery of requested services 515 to the WTRU 501.

The use of a MOD WTRU utilizing VCM as in FIG. 5 removes a user's dependency on a single MNO. The WTRU 501 implementing a VCM may access any MNO able to verify credentials supplied by the VCM. Once the VCM is validated, the VCM may also be configured to provide UICC functionality to be able to access legacy networks not yet capable of interacting with a VCM.

The multi operator (or operator agnostic) system may allow a user to access additional services other than those provided in their subscription/contract based system, while also allowing MNOs to provide those services to a broader range of users by directly charging users for services or by charging third party service providers or financial institutions for using the network of the MNO. The MNO may also charge for providing information that enables those services, including but not limited to customized billing/charging, promotional services, group addressing capabilities, identity services, customized media content, and content selection based on NW QoS offering, or statistics.

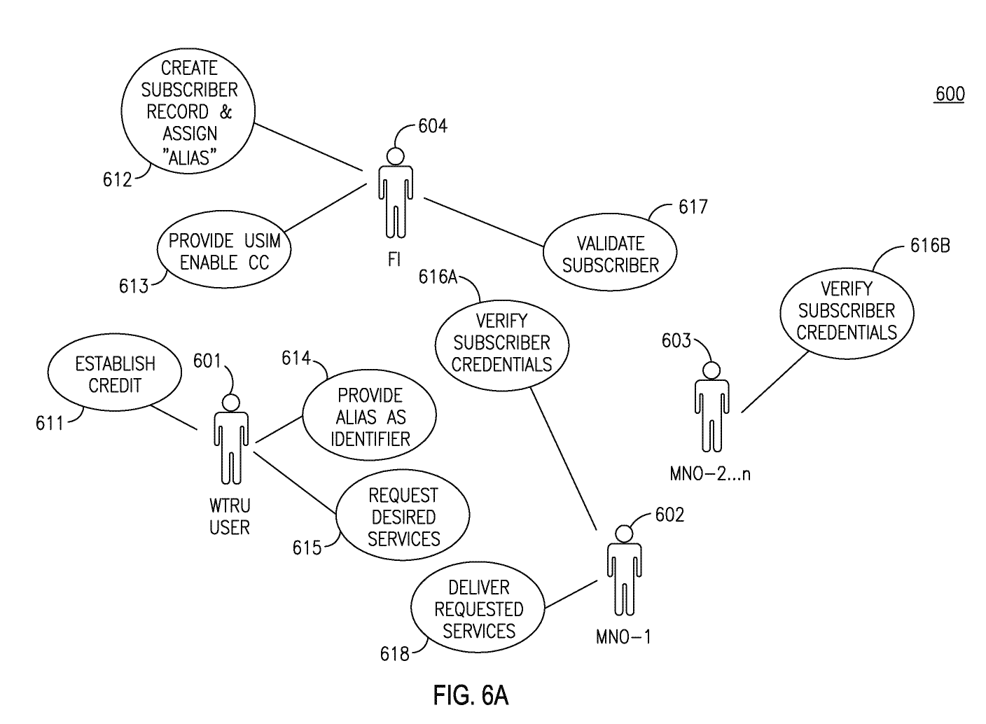

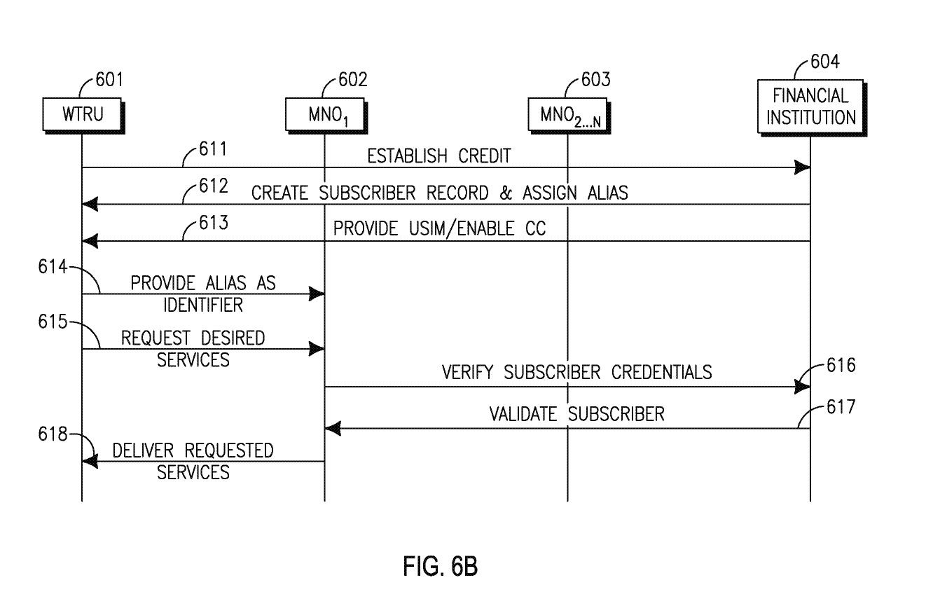

In one embodiment, a credit card-based subscription may be used. FIG. 6A shows an example of a credit-card based subscription system 600. The actors in such a system may include a WTRU user 601, MNO₁ 602, MNO_{2 . . . n} 603 and a financial institution (FI) 604 (for example, a credit card company). Pre-conditions for obtaining services in such a system include a WTRU user 601 obtaining a credit card (CC) 611 from a FI 604. The FI 604 may provide a USIM-enabled CC 613, create a subscriber record and create an alias 612, and validate the user 617. MNO₁ 602 or MNO_{2 . . . n} 603 and the FI 604 may implement a bank-transaction based on dynamic charging. In a successful case, the WTRU user 601 may use desired services 615 from any one or more of the MNOs following providing that MNO or MNOs with the alias as an identifier 614. The MNOs may verify the subscriber credentials 616a and 616b based on the alias and then one or more MNOs may deliver requested services 618. In a failed case, the WTRU user 601 may be denied service in all contacted networks for a given service.

FIG. 6B shows a credit-card based subscription signal flow diagram for the credit-card based subscription system. FIG. 6B shows the relationship among the WTRU 601, MNO₁ 602, MNO_{2 . . . n} 603 and a financial institution (FI) 604 and does not require a specific order. Furthermore, there may any number of MNOs in the system 600. A WTRU 601 user may obtain a credit card from an FI in order to establish credit 611. The FI may create a subscriber record and assign an alias 612 and may provide a USIM and enable the credit card (CC) 613. The user of the WTRU 601 may provide the alias as an identifier 614 to a MNO₁ 602 or MNO_{2 . . . n} 603 and request desired services 615. The services requested by the WTRU user may be services from SPs with an alliance with the MNOs, or services from SPs without an alliance with the MNO, or services offered directly by the MNOs themselves. In FIG. 6B, the user of the WTRU 601 provides MNO₁ 602 with the alias as an identifier 614 and requests services 615 from MNO₁ 602. MNO₁ 602 may verify the subscriber credentials 616 of the user of the WTRU 601. If the user of the WTRU 601 has credit with the FI 604, the FI 604 may validate the subscriber 617. MNO₁ 602 (or another MNO in the system) may then provide the desired services 618. If the user of the WTRU 601 does not have credit or sufficient funds with the FI 604, user of the WTRU 601 may be denied service in all contacted networks for a given service.

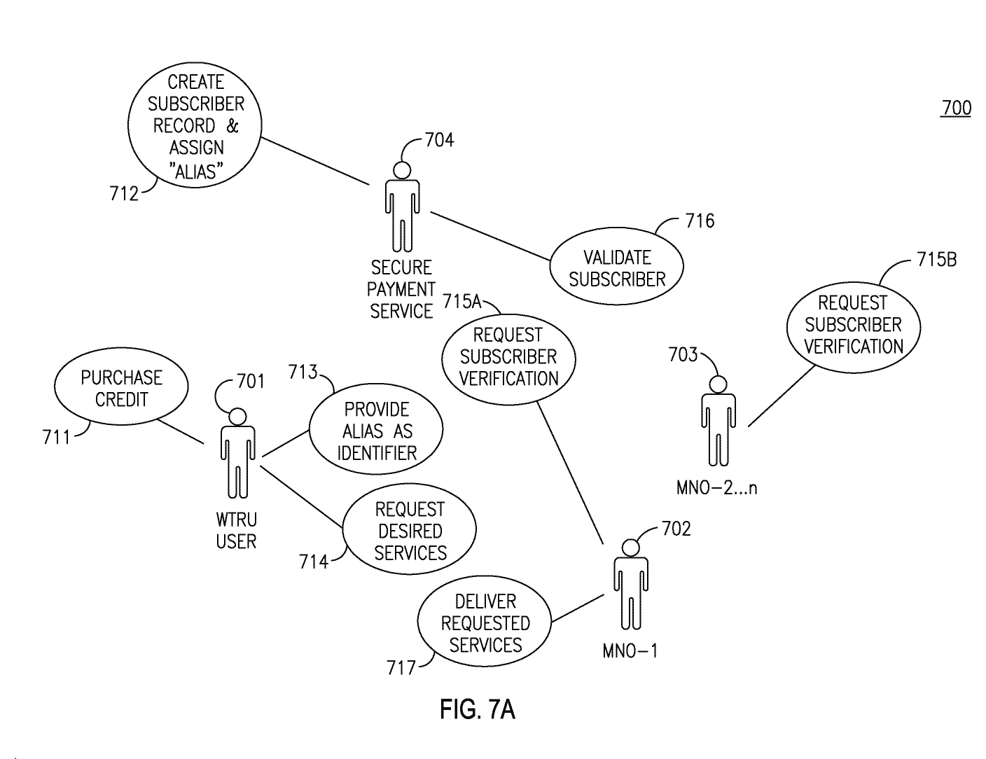

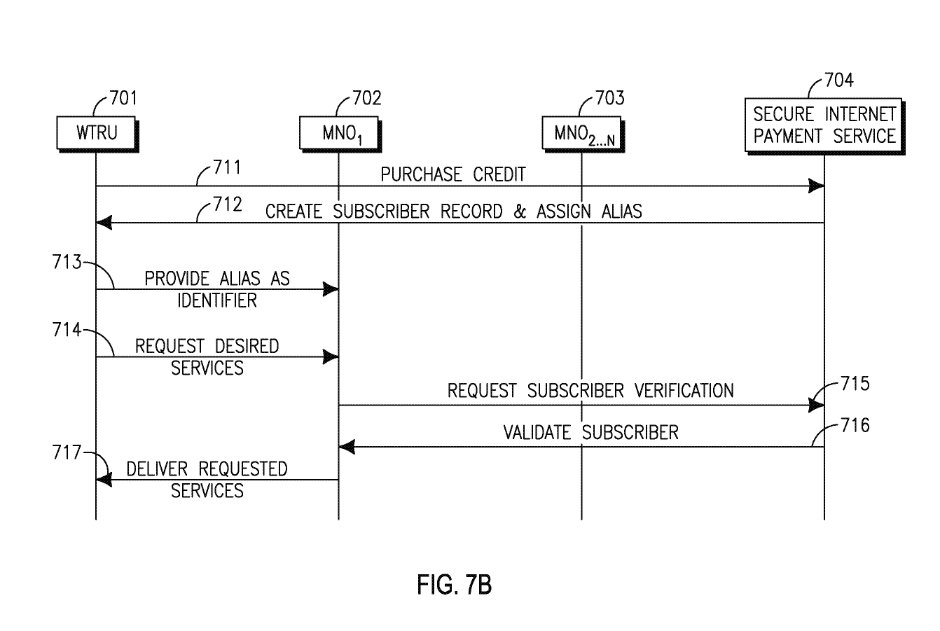

FIG. 7A shows use of a pre-paid subscription system 700 that is non-operator based according to another embodiment. The actors in such a system may include a WTRU user 701, MNO₁ 702, MNO_{2 . . . n} 703, and a secure internet payment service 704 such as Paypal. Pre-conditions for obtaining services in such a system include the WTRU user 701 purchasing a loadable USIM enabled Debit Card and purchasing prepaid credit 711 through a secure internet payment service 704, and an MNO implementing a bank-transaction based on dynamic charging. In a successful case, the WTRU user 701 may use desired services 714 from any of the MNOs following providing that MNO with the alias as an identifier 713. The MNOs may verify the subscriber credentials 715a and 715b based on the alias and then after the secure internet payment service 704 validates the subscriber 716, one or more MNOs may deliver requested services 717. The services requested by the WTRU user may be services from SPs with an alliance with the MNOs, or services from SPs without an alliance with the MNO, or services offered directly by the MNOs themselves. In a failed case, the WTRU user 701 may be denied service in all contacted networks for a given service.

FIG. 7B shows a pre-paid, generic (non-operator based) subscription signal flow diagram. FIG. 7B shows the relationship among the WTRU 701, MNO₁ 702, MNO_{2 . . . n} 703 and a secure payment service 704 and does not require a specific order. The Secure Payment Service 704 acts as a guarantor of the ability of the WTRU 701 user to pay. A WTRU 701 user may purchase credit 711 such as a loadable USIM enabled Debit Card or such as a prepaid credit through a secure internet payment service 704, such as PayPal. The secure internet payment service 704 may create a subscriber record and assign an alias 712 for the WTRU user 701. The user of the WTRU 701 may provide the alias as an identifier 713 to a MNO₁ 702 or MNO_{2 . . . n} 703 and request desired services 714. MNO₁ 702 may request subscriber verification 715. The secure internet payment service 704 may validate a subscriber 716. The MNO₁ 702 may then deliver the requested services 717. If the user of the WTRU 701 does not have credit or sufficient funds through the secure internet payment service 704, the WTRU user 701 may be denied service in all contacted networks for a given service.

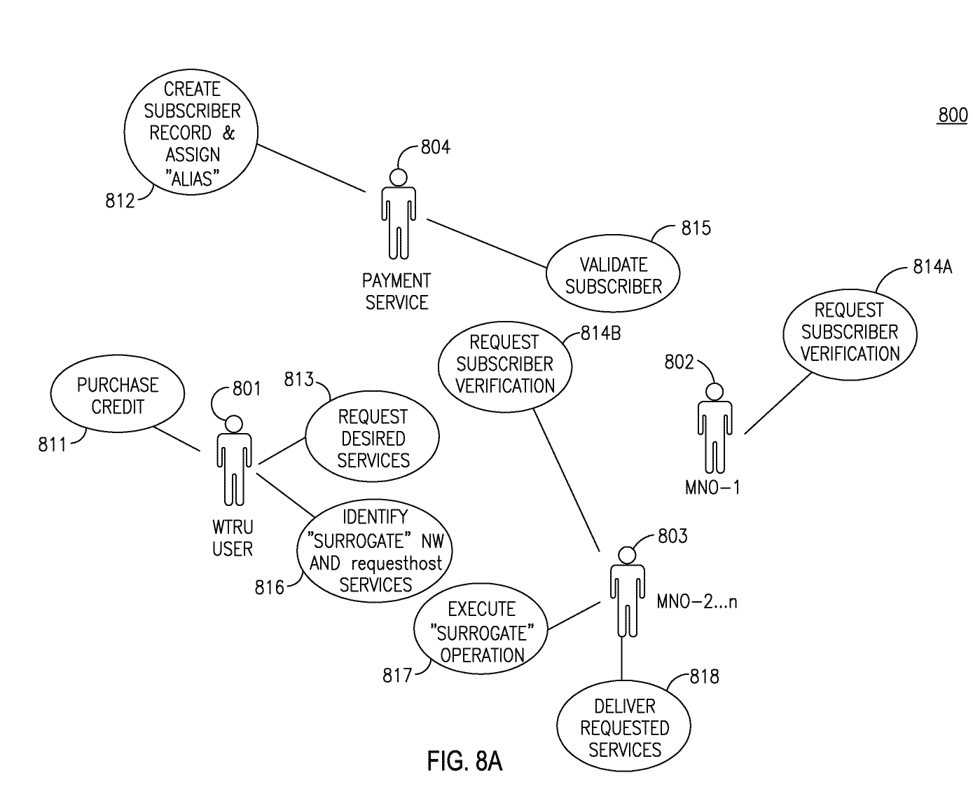

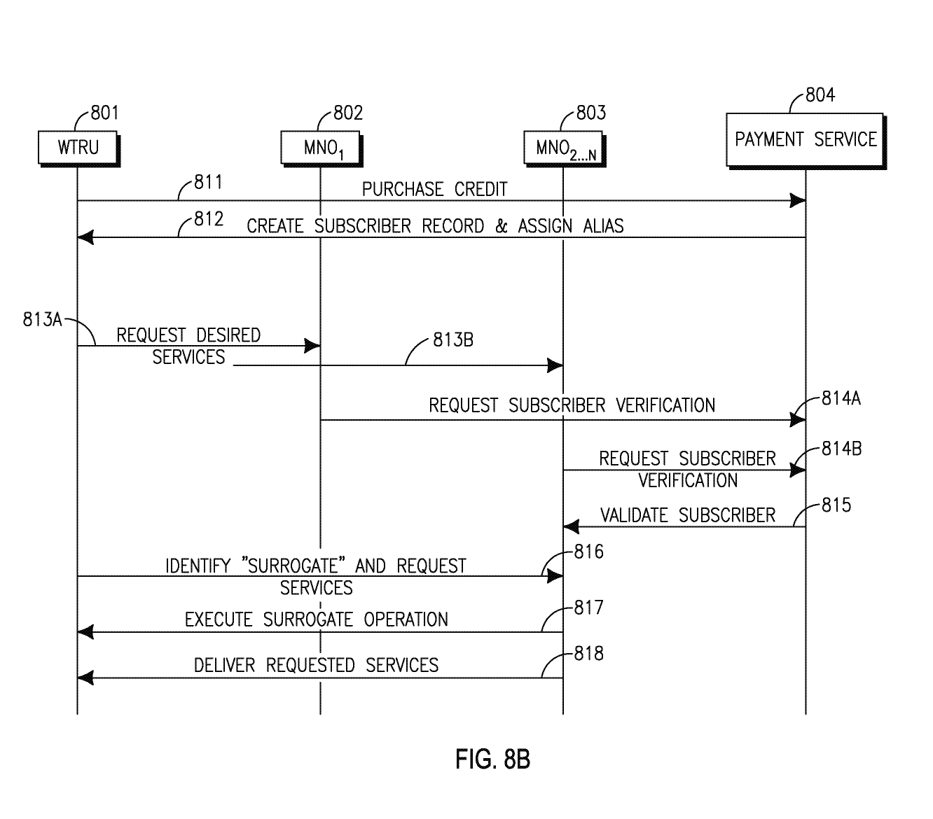

FIG. 8A shows use of a surrogate MNO 800. The actors in such a system may include a WTRU user 801, MNO₁ 802, MNO_{2 . . . n} 803 (the surrogate MNO), and a secure payment service 804, such as Paypal. Pre-conditions for obtaining services in such a system include a WTRU user 801 being equipped as a MOD including a VCM, which supports surrogate MNO acquisition procedures. Surrogate MNO acquisition procedures permit mutual authentication, establishment of credit limits, and establishment of a service suite. Another precondition includes the MNOs implementing support for surrogate procedures. This system 800 does not rely on the existence of a roaming agreement between MNO₁ 802 and MNO_{2 . . . n} 803. One of the MNOs may be the WTRU user's 801 primary MNO and another MNO may serve as a surrogate to the WTRU user 801 when the WTRU user 801 desires services outside of the primary MNO coverage. In a successful case, the WTRU user 801 may purchase credit 811 and request services 813. The MNOs may then request subscriber verification 814a and 814b, which may then be validated by the secure payment service 804. The surrogate MNO may then execute surrogate operation 817. The WTRU user 801 may then identify the surrogate MNO and request services 816, which may then be delivered by the surrogate MNO 818. The services requested by the WTRU user may be services from SPs with an alliance with the MNOs, or services from SPs without an alliance with the MNO, or services offered directly by the MNOs themselves. In a failed case, the WTRU user 801 is not able to access the surrogate MNO.

FIG. 8B shows a Surrogate Mobile Network Operator signal flow diagram. FIG. 8B shows the relationship among the WTRU 801, MNO₁ 802, MNO_{2 . . . n} 803, and a Payment Service 804 and does not require a specific order. The WTRU user 801 may purchase credit 811 from a financial institution or secure internet payment service 804, such as PayPal. The payment service 804 may then create a subscriber record and assign an alias 812 for the WTRU user 801. The WTRU user 801 may then request desired services 813a from a primary network operator, MNO₁ 802 and may also request desired services 813b from a surrogate network operator MNO_{2 . . . n} 803. The primary network operator, MNO₁ 802 may then request subscriber verification 814a. The surrogate network operator MNO_{2 . . . n} 803 may also request subscriber verification 814b. The payment service 804 may then validate the subscriber 815 for the surrogate network operator MNO_{2 . . . n} 803. The surrogate network operator MNO_{2 . . . n} 803 may then execute a surrogate operation 816 and deliver the requested services 817.

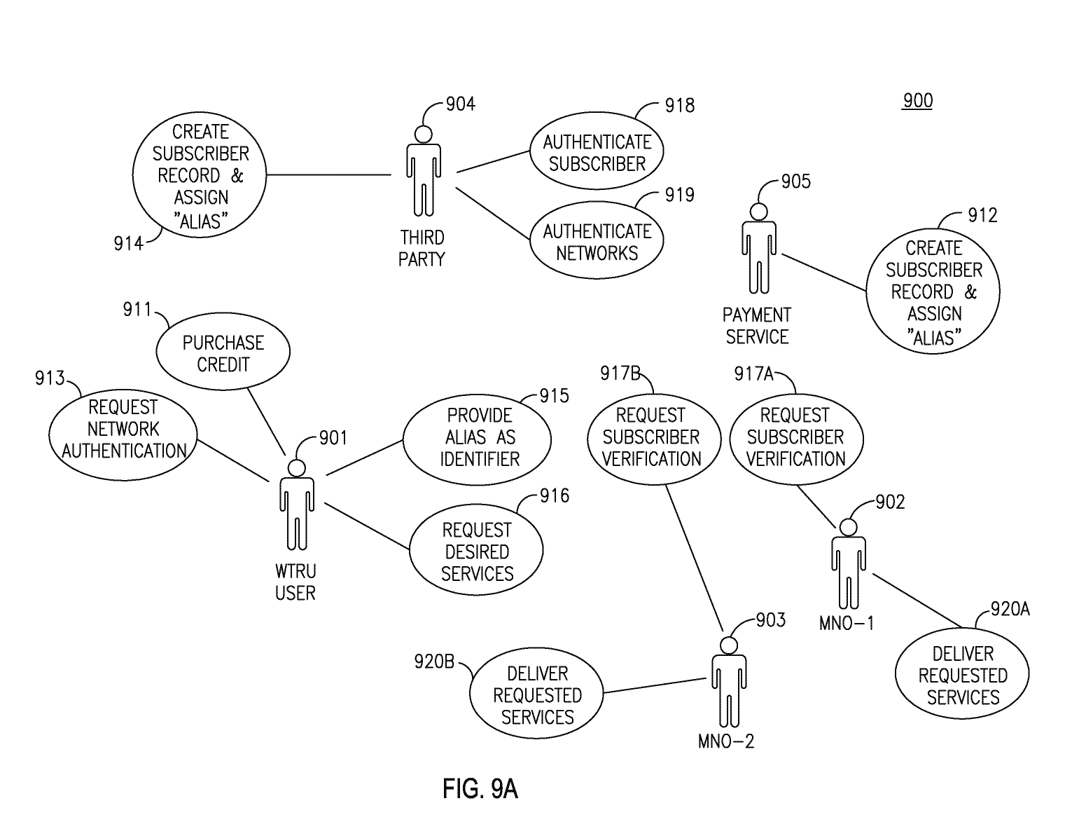

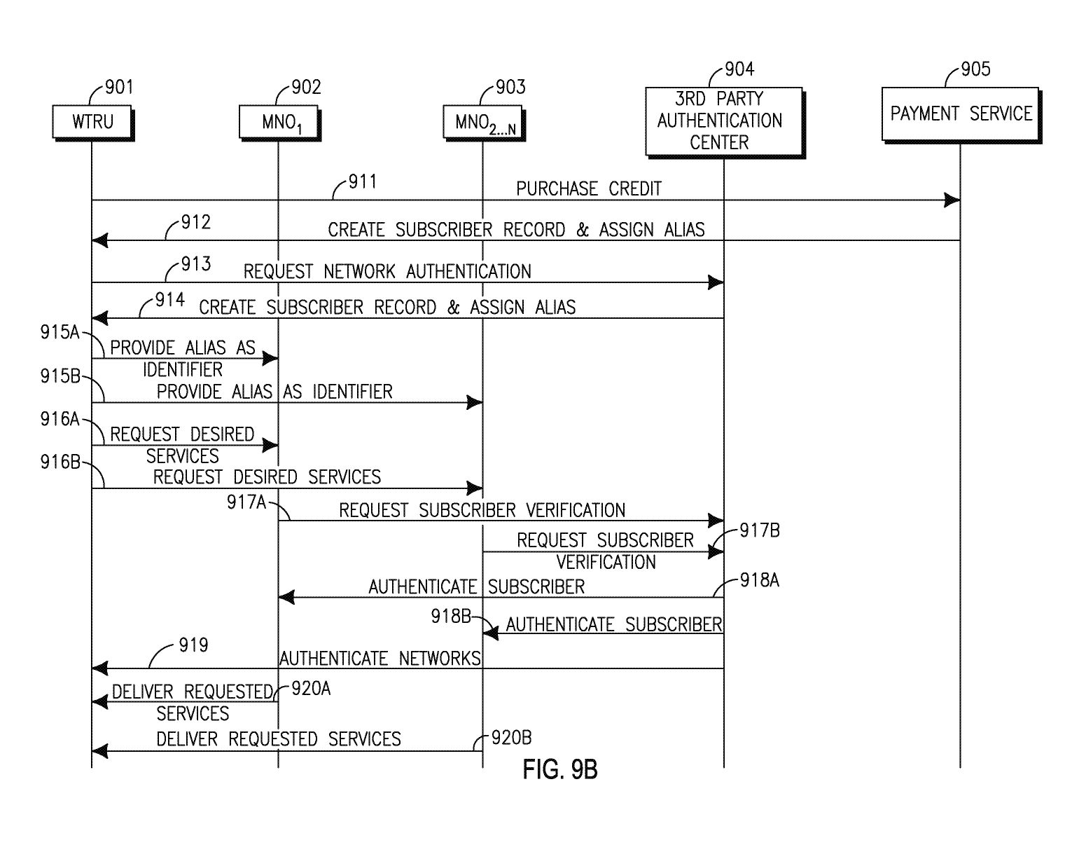

FIG. 9A shows use of multi-operator services with third-party authentication 900 according to yet another embodiment. The actors include a WTRU user 901, MNO₁ 902 and MNO_{2 . . . n} 903, a third party authentication center 904, and a secure internet payment service 905. In this system, the third party authentication center 904 guarantees to the WTRU user 901 and secure internet payment service 905 that both parties' identities have been verified. When a WTRU user 901 would like to purchase services 916 from different MNOs 902 and 903 from which it does not have a subscription, a third-party 904 may be used to authenticate the MNO 919 to the WTRU user 901 and to authenticate the WTRU user 901 to the network 918. After authentication is performed, a subscriber may purchase services through credit 911 from the MNOs via either an online money transfer service or via credit card. The pre-conditions include the WTRU user 901 is equipped as a MOD including a VCM, and that both the WTRU user 901 and the MNOs support third party procedures for mutual authentication of the MNO and the WTRU user 901, the establishment of credit limits and a service suite, and the MNO implementing virtual number service (allowing the WTRU user 901 to be accessed by its original MSISDN number at any location). In a successful case, the WTRU user 901 may purchase credit 911 and request network authentication 913. The third party authentication center 904 may then create a subscriber record and assign an alias 914. The MNOs may then request subscriber verification 917a and 917b, which may then be validated by the secure payment service 905. The third party authentication center 904 may then authenticate the WTRU user 901. The WTRU user 901 may then provide the alias as an identifier 915 and request services 916. The WTRU user 901 may then connect to MNO₁ 902 for one service 920a such as voice and to MNO_{2 . . . n} 903 for other desired services 920b such as data. The services requested by the WTRU user may be services from SPs with an alliance with the MNOs, or services from SPs without an alliance with the MNO, or services offered directly by the MNOs themselves. In a failed case, the subscriber is denied service in either or both networks.

FIG. 9B shows a signal flow diagram of a user purchasing services from different networks, which are authenticated by a third party. FIG. 9B shows the relationship among the WTRU 901, MNO₁ 902, MNO_{2 n} 903, a third party authentication center 904, and a Payment Service 905 and does not require a specific order. The WTRU user 901 may purchase credit 911 from a financial institution or secure internet payment service 905, such as PayPal. The payment service 905 may then create a subscriber record and assign an alias 912 for the WTRU user 901. The WTRU user 901 may then request network authentication 913 from the third party authentication center 904. The third party authentication center 904 may then create a subscriber record and assign an alias 914 for the WTRU user 901. The user of the WTRU 901 may provide the alias as an identifier 915a to a first network operator, MNO₁ 902 and provide the alias as an identifier 915b to one or more other network operators, MNO_{2 . . . n} 903. The user of the WTRU 901 may then request desired services 916a and 916b from the network operators MNO₁ 902 and MNO_{2 . . . n} 903. MNO₁ 902 may request subscriber verification 917a from the third party authentication center 904. The MNO_{2 . . . n} 903 may also request subscriber verification 917b from the third party authentication center 904. Once the third party authentication center 904 authenticates the subscriber 918a to MNO₁902 and authenticates the subscriber 918b to MNO_{2 . . . n} 903, the third party authentication center may authenticate the networks 919 to the WTRU user 901. The network operator MNO₁ 902 may then deliver a first requested service 920a. The network operator MNO_{2 . . . n} , 903 may then deliver a second requested service 920b to the WTRU user 901.

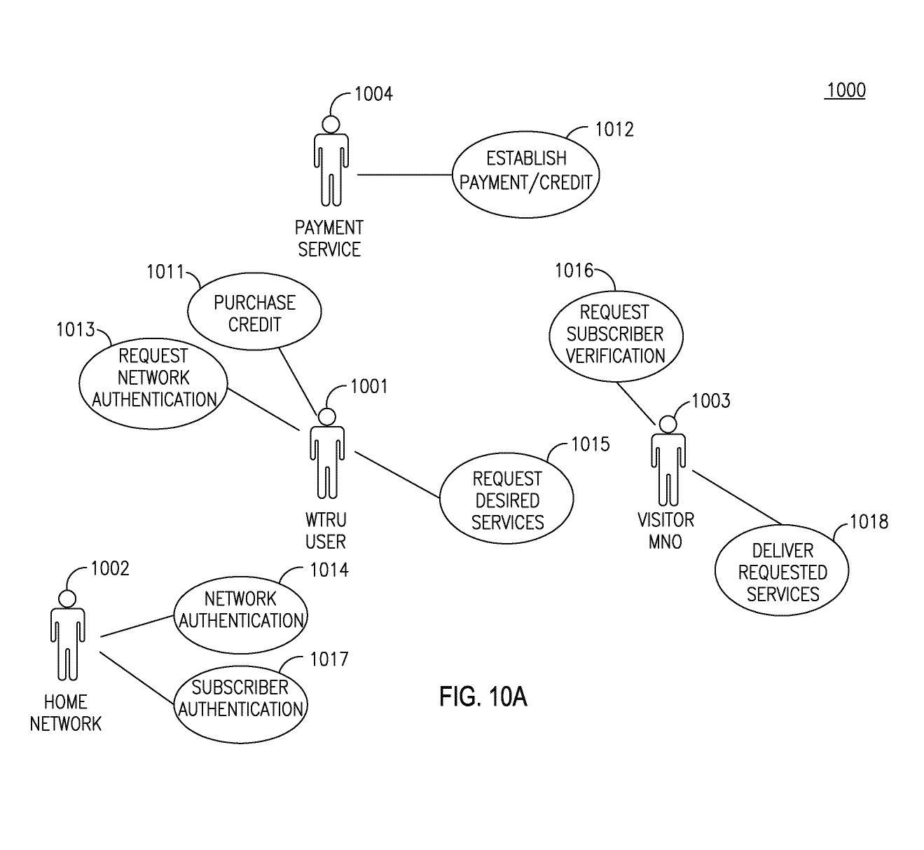

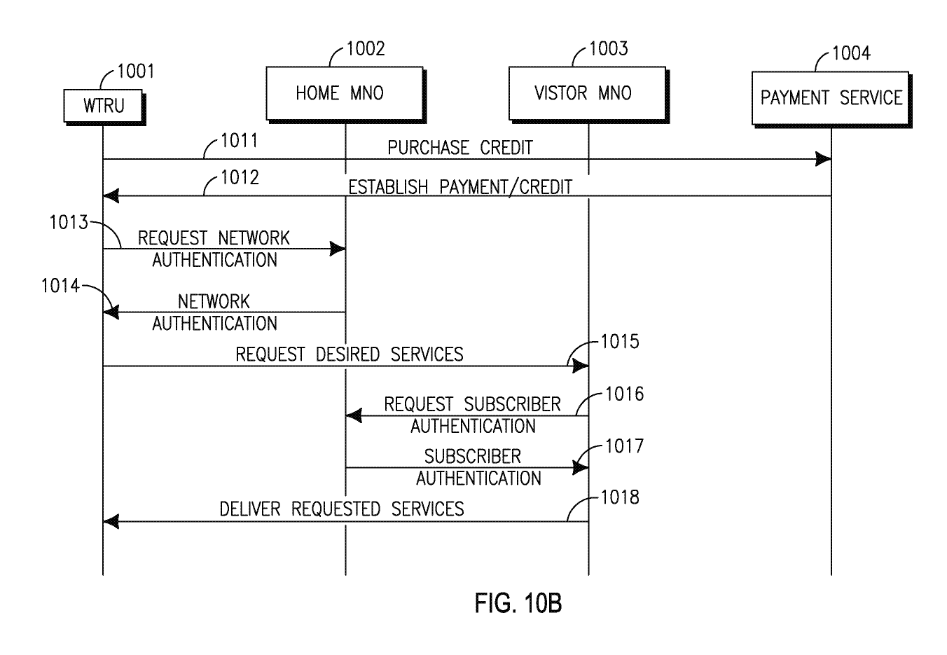

FIG. 10A shows a home network assist subscription 1000 in accordance with yet another embodiment. The actors include a WTRU user 1001, the home MNO 1002, a visitor MNO 1003, and a secure internet payment service or credit card company. The pre-conditions include the WTRU user 1001 device being equipped as a MOD including a VCM, the home MNO 1002 having a roaming agreement with the visited MNO 1003, and establishment of credit limits and a service suite. When a WTRU user 1001 is roaming on a visited network, the WTRU user 1001 may want to purchase service directly from the visited MNO 1003 directly in order to avoid high roaming charges from the WTRU user's 1001 home MNO 1002. Purchasing service directly from the visited network allows the user to avoid prohibitively high roaming charges and to avoid being forced to turn off their WTRU in order to avoid roaming charges when outside the home MNO's 1002 coverage. The user may also purchase a temporary subscription SIM with prepaid credit valid for only a limited time in this system. Using a home network assist subscription, a MNO 1002 remains the home MNO for the WTRU user 1001, but the WTRU user 1001 is allowed to choose another MNO 1003 while traveling. As a result, MNOs may obtain increased roaming traffic and therefore increased roaming revenue. The user's home MNO 1002 may remain the main operator for the WTRU user 1001 and at the same time has a provision that allows the WTRU user 1001 to choose a visitor MNO while traveling, which may include an additional charge. Such provisions may be pre-configured on the WTRU 1001, the WTRU 1001 SIM, the WTRU 1001 virtual SIM, or be signaled to the WTRU 1001 (or its SIM or virtual SIM) via SIM Over The Air (OTA) signaling, Open Mobile Alliance (OMA) DM signaling, Non-Access Stratum (NAS) layer signaling, or Access Stratum (AS) layer signaling such as RRC (Radio Resource Control sublayer) signaling. As a result, the WTRU user 1001 may select any MNO of their choice while roaming. This system may permit a WTRU 1001 to increase roaming usage thereby increasing the overall roaming traffic and revenue to MNOs.

The WTRU user 1001 may purchase 1011 from a payment service 1004 and request network authentication 1013. The WTRU user's 1001 home MNO 1002 may authenticate both the visited network 1014 and the subscriber 1017 in response to the visitor MNO 1003 request for subscriber verification 1016. The WTRU user 1001 may then request services 1015 from the MNO via the payment service 1004 which established credit 1012 for the WTRU user 1001. In a successful case, the subscriber receives desired services 1018 from the visited MNO 1003. In a failed case, the WTRU user 1001 is not able to access the MNO 1003.

FIG. 10B shows a home network assist signal flow diagram. FIG. 10B shows the relationship among the WTRU 1001, home MNO 1002, visitor MNO 1003 and a Payment Service 1004 and does not require a specific order. Furthermore, there may any number of MNOs in the system. The WTRU user 1001 may purchase credit 1011 from a financial institution or secure internet payment service 1004, such as PayPal. The Payment Service 1004 may establish the payment ability or credit 1012 with the WTRU user 1001. The WTRU user 1001 may request network authentication 1013 from its home MNO 1002. The home MNO 1002 may then authenticate 1014 the visitor MNO 1003 for the WTRU user 1001. WTRU user 1001 may then request desired services 1015 from the visitor MNO 1003. The visitor MNO 1003 may then request subscriber authentication 1016 from the home MNO 1002, which in response may provide subscriber authentication 1017 for the visitor MNO 1017. The visitor MNO 1018 may then deliver the requested services 1018 for the WTRU user 1001.

When operating as a MOD, the WTRU may register with MNOs and request/obtain services. If the user buys a USIM/SIM, information may be loaded with the user's request/consent, which provides information on services offered by MNOs, associated rates, and other settings. There also may be packages of MNOs and services that may be referenced by a group identity. Services and MNOs in a multi operator access system may be made in an automatic or manual mode. The WTRU may be allowed to register with multiple MNOs, optionally using multiple RATs, where the choice of PLMN and/or RAT is based on the desired services of the user. MNO selection may be based on configuration, past QoS statistics, user input, and/or path or network testing/probing. The MNO may include the Service Bulletin Board or related information. System Information Blocks (SIBs) may be used for locating the Service Bulletin Board. The Service Bulletin Board may be on one or more special APNs; in some special broadcast or multicast channel such as the cell broadcast service or MBMS; or in a special SIB broadcast at a scheduled time in order to minimize the impact to system resources. A NAS message specially requested by the WTRU may also be used to locate a Service Bulletin Board. A MOD WTRU may request this Service Bulletin Board information message any time from an MNO connection.

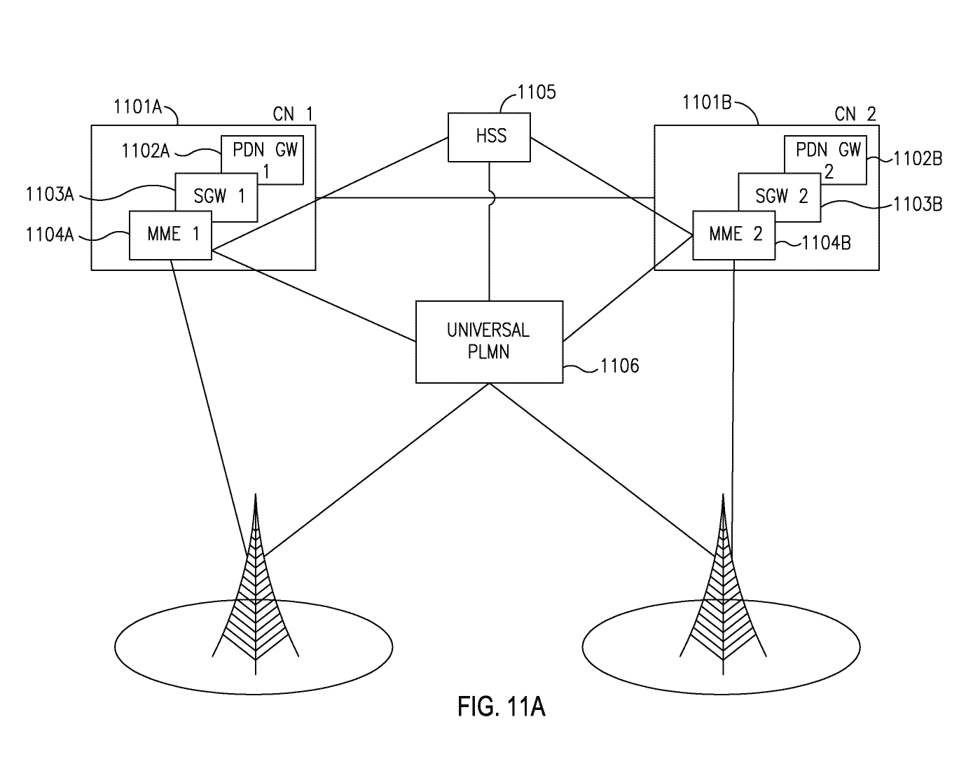

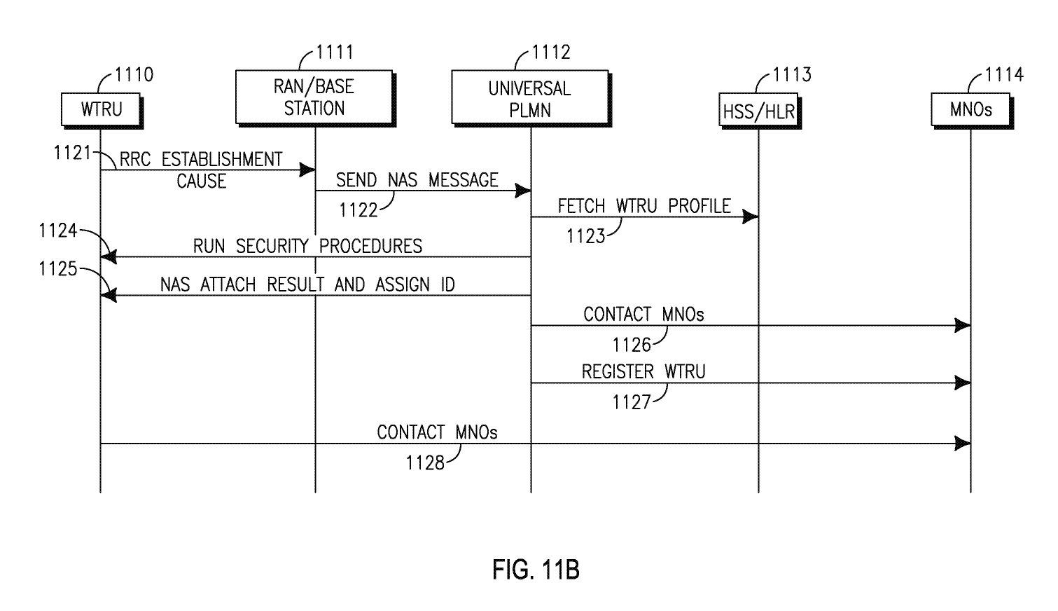

FIG. 11A shows a network architecture with a centralized Core Network (CN) Node 1100 in which a WTRU may select MNOs and services as described above. Referring to FIG. 11A, a universal PLMN/MNO 1106 forms a centralized node connected to one or more MNO CNs 1101a and 1101b. A MOD WTRU may register with the universal PLMN/MNO 1106 which in turn may register the WTRU to any of the MNO CNs 1101a and 1101b for which the WTRU may be authorized to access. The universal PLMN/MNO 1106 may contact at least one MNO including at least one MME 1104a and 1104b, SGW 1103a and 1103b, and PDN GW 1102a and 1102b per MNO CN. The universal PLMN/MNO 1106 may also send a list of all available PLMNs/MNOs to the WTRU, which can then be saved in the WTRU memory. Alternatively, a WTRU may contact the universal PLMN/MNO 1106 in order to initiate a download of a set of PLMNs/MNOs that are available for access. The WTRU may then perform registration with each PLMN/MNO independently. In both procedures, the PLMNs/MNOs may coordinate with each other to determine the services to be provided to the WTRU.

MNO nodes such as HSS or PCRF may also be shared by the other MNOs. For example, the HSS may be managed by a third party. Charging may be through a subscription, on a pre-paid basis, or on demand. The user may be directly charged to a credit card account on demand as well.

WTRUs supporting MOD operation with a universal PLMN/MNO 1106 may also support operation with a single MNO. The selection of mode may be made when the WTRU powers up and verifies its configuration settings, which may be saved in memory or in a USIM/SIM. When the WTRU is configured to operate in a MOD mode, it may connect with a universal PLMN/MNO 1106.

After power on, the WTRU operating as a MOD may choose any cell that meets its selection criteria, including but not limited to the radio quality criteria, independent of the actual PLMN/MNO 1106 being broadcast. The PLMN/MNO 1106 may alert WTRUs that multi operator access or a universal PLMN/MNO 1106 is supported by broadcasting that information. Alternatively, the WTRU may have hardcoded information such as cell ID, CSG ID, or global cell ID that may identify the PLMNs/MNOs 1106 that support multi operator access. The WTRU MOD may then choose a cell based on a broadcast indicator of multi operator access or a universal PLMN/MNO 1106, and/or based on the WTRU hardcoded configuration information.

Alternatively or additionally, MNO CN nodes may be distributed. In the distributed architecture the WTRU may perform at least one registration to at least one MNO 1106, which may be based on configurations in the USIM/SIM such as a list of MNOs to which it may register for services.

FIG. 11B shows a registration procedure according to one embodiment. The WTRU 1110 may send an RRC establishment cause 1121 to a RAN/base station 1111 to indicate that the WTRU 1110 is operating in MOD mode and requests contact with a universal PLMN/MNO 1112 for multi operator access or service based operation. The WTRU 1110 may also indicate in this RRC message the requested set of services. The RRC message sent 1121 may have the PLMN IE of the message set to a value that indicates a universal PLMN/MNO 1112. For example, the RRCConnectionSetupComplete message in LTE or the Initial Direct Transfer message in UTRAN may be set to indicate a universal PLMN/MNO 1112. The WTRU 1110 may set the Core Network domain IE to any value including a value such as “centralized CN” to indicate a request for a universal PLMN/MNO 1112.

Based on the receipt of an establishment cause 1121 that is set for service based operation or based on the value of the chosen PLMN, the RAN/base station 1111 may send a NAS message 1122 to a universal PLMN/MNO 1112. The RAN may also use the Core Network domain IE indication to forward the NAS message to a universal PLMN/MNO 1112. This NAS message may also be defined for use by the WTRU 1110 and the universal PLMN/MNO 1112. For example, a type of attach message may be defined or a value for the Attach Type IE may be defined. This may be used by the WTRU 1110 to communicate with the universal PLMN/MNO 1112. The WTRU 1110 may also use any existing NAS message for this purpose. Moreover, the WTRU 1110 may indicate in the NAS message its capability to operate in multi operator access mode or service based operation mode and a minimum set of services that are desired.

When the NAS message reaches the universal PLMN/MNO 1112, it may then fetch the WTRU's 1110 subscription profile from a HSS/HLR 1113. An interface between the universal PLMN/MNO 1112 and the HSS/HLR 1113 may enable the universal PLMN/MNO 1112 to obtain the WTRU 1110. Alternatively, existing interfaces such as those among a MME, SGSN, MSC/VLR and HSS/HLR 1113 may be used with modified messaging.

The WTRU's 1110 subscription profile at the HSS/HLR 1113 may define or use new parameters that indicate that the WTRU 1110 is permitted for “multi operator access” or “service based operation.” The WTRU's 1110 subscription profile at the HSS/HLR 1113 may include information on the set of services that may be obtained from any MNO 1114 or via the universal PLMN/MNO 1112. For example, such information may include a set of services that are subject to flat fee charging and another set of services that are subject to an additional rate. The WTRU's 1110 subscription profile may also include an indication regarding the quality of service (QoS). The WTRU's 1110 subscription profile may also include a list of MNOs 1114 that the WTRU 1110 is permitted to access.

After the WTRU's 1110 subscription profile has been fetched 1123, the universal PLMN/MNO 1112 may run security procedures 1124 with the WTRU 1110 using any procedure or algorithm. The universal PLMN/MNO 1112 may then terminate the registration phase by responding with a new NAS message to indicate success 1125. For example, an IE or attach result type IE in the NAS message may be sent to the WTRU 1110 to indicate successful registration.

Alternatively, the universal PLMN/MNO 1112 may contact at least one MNO 1126 including at least one MME, SGSN, MSC/VLR and notify these CN nodes about the service request from the WTRU 1110 after the WTRU's 1110 profile has been obtained 1123. The WTRU 1110 may be identified by its International Mobile Subscriber Identity (IMSI). The universal PLMN/MNO 1112 may also register 1127 the WTRU 1110 to one or more MNOs 1114 that provide the requested/permitted services.

The universal PLMN/MNO 1112 may select a MNO 1114 based on information regarding the set of services that are provided by each MNO 1114. The universal PLMN/MNO 1112 may register 1127 the WTRU 1110 for a subset of services that are provided by the MNO 1114. Each MNO 1114 to which the WTRU 1110 is being registered by the universal PLMN/NINO 1112 may also provide the list of services available. The list of services that are permitted for a WTRU 1110 may also be obtained by the MNO 1114 from the HLR/HSS 1113 and be provided to the universal PLMN/MNO 1112 during registration 11127 to confirm WTRU 1110 eligibility. Alternatively, this may be based on configurations in the MNO 1114 policies.

The universal PLMN/MNO 1112 may save the profile of the WTRU 1110 in the same way the MNO 1114 saves it. For example, identities, security contexts, timers, or allowed services may be saved in the universal PLMN/MNO 1112. Also, the universal PLMN/MNO 1112 may assign a global unique identification 1125 to the WTRU 1110 that may be used by all MNOs 1114.

Alternatively, the identification assigned may be unique to each MNO. The universal PLMN/NINO 1112 may provide the MNO 1114 with the assigned identity during registration 1127 and may indicate whether it is unique to the MNO 1114 or global. Alternatively, the MNO 1114 may determine this information about the identity from its format. For example, the first bit may be used with a specific value to indicate whether the identity is global or local to the MNO. When the universal PLMN/MNO 1112 completes the registration procedure for the WTRU 1110 it may indicate whether registration for multi operator access/service based operation mode was successful or not. An IE may indicate this information. This registration response may also indicate to the WTRU 1110 that it is required to independently register with a particular MNO 1114, which may depend on the policy of the particular MNO 1114.

If the registration for multi operator access/service based operation mode is accepted, the universal PLMN/MNO 1112 may provide the WTRU 1110 with a list of identities for each MNO 1114 or a global identity to be used for all MNOs 1114 and their associated rates. The WTRU 1110 may store the list of services provided by each MNO 1114 and their corresponding identities. The user of the WTRU 1110 may then access this list of services provided by each MNO 1114 and their corresponding identities and rates.

After the WTRU 1110 receives a registration response the universal PLMN/NINO 1112, the WTRU 1110 may contact and perform a direct registration 1128 with the list of MNOs 1114 received in the registration procedure as explained above. The MNO 1114 and the WTRU 1110 may also run separate security procedures and algorithms. Alternatively, the WTRU may use the security keys and algorithms established with the universal PLMN/MNO 1112, which may be retrieved by the MNOs 1114 or sent to the MNOs by the universal PLMN/MNO 1112.

The universal PLMN/MNO 1112 may continue acting as the primary network node following registration as described above. Alternatively, the universal PLMN/MNO 1112 may indicate to the WTRU that a specific MNO 1114 is to be considered as a primary MNO 1114, while any other MNOs 1114 are secondary. In one embodiment the WTRU 1110 display indicates to the user the identities of the primary and secondary MNOs 1114, and/or the MNO 1114 actively serving the WTRU 1110 and the MNO 1114 that is inactive.

The MNOs 1114 may also communicate with each other to coordinate a service that may jointly be provided to a WTRU 1110. When an MNO contacts the HSS/HLR 1113 for registering a WTRU 1110 registered with another MNO 1114 or universal PLMN/MNO 1112, an indication may be included in the message towards the HSS/HLR 1113 such that the HSS/HLR 1113 maintains context and location information with at least one MNO 1114 for that WTRU 1110.

The WTRU 1110 may also maintain a list of preferred MNOs 1114 and the method of managing the list may be configured. The WTRU's 1110 USIM/SIM may maintain such lists as well. The initial list may be empty, and then the WTRU 1110 may start populating the list through user input. The WTRU may also add a service or MNO to a “preferred service provider list” or to a “preferred operators list” whenever a request for access has been granted. If a request for access fails, the WTRU user may delete that MNO from the list, or the WTRU may be configured to automatically remove the MNO from the list. The WTRU's 1110 USIM/SIM may also keep the list of services/MNOs and their respective access methods including but not limited to APN or request code.

Alternatively, the WTRU may perform registration as above individually with each MNO 1114 when operating in a distributed CN node architecture. For example, the NAS message indicating support for multi operator access/service based operation mode also applies in a distributed architecture. Moreover, the first MNO 1114 to which the WTRU 1110 registers may act as the universal PLMN/NINO 1112 as explained above but using a specific PLMN/MNO identity regardless of what is broadcast by the RAN/base station 1111.

Alternatively, the WTRU may register to a previously known MNO 1114 as a primary MNO 1114, which in turn may instruct the WTRU 1110 to register with secondary MNOs 1114 for specific services. As a result, the WTRU 110 may receive instruction to register with at least one additional MNO for some services. The WTRU 1110 may then perform the registration procedure as described herein. The WTRU 1110 may register with each MNO 1114 in an order corresponding to the priority associated with the desired service. For example, the order may be based on when the services are required by the user. This order may also be saved in the WTRU 1110 configuration settings. During registration with the secondary MNOs, the WTRU may indicate the set of services that are desired by the WTRU 1110. The WTRU may also include the identity of its other registered MNOs 1114. The contacted MNO 1114 may then in turn contact the other registered MNOs 1114 to retrieve the profile of the WTRU 1110. Sharing the WTRU 1110 profile with other MNOs may enable the use of shared security contexts or identities and other configuration settings.

A secondary MNO 1114 may indicate that its registration is a secondary registration when contacting the HLR/HSS 1113. The secondary MNO 1114 may accomplish this by using its Update Location message to indicate a secondary registration. Doing so may enable the HSS/HLR 1113 to maintain the registration/context with the primary MNO and the other secondary MNOs 1114 rather then send a cancel location message to other MNOs 1114 that had previously registered the WTRU 1110.

When a WTRU 1110 first registers with a primary MNO to obtain services, the primary MNO 1114 may instruct the WTRU 1110 to obtain services not provided by the primary MNO from a secondary MNO. The WTRU may then obtain services provided by the primary MNO and obtain any remaining desired services from the secondary MNO, or the WTRU may cancel registration with the primary MNO and seek another MNO to register with as a primary MNO.

The WTRU also may include a parameter that specifies that it is already registered to at least one MNO. This parameter may be part of the message that is used to request a service from an additional MNO 1128. The WTRU may include this parameter while registering with a secondary MNO that the primary MNO had suggested to the WTRU. The secondary MNO registration may be an attachment procedure, or it may be a simplified procedure including but not limited to a Tracking Area Update, Routing Area Update, or Location Area Update.

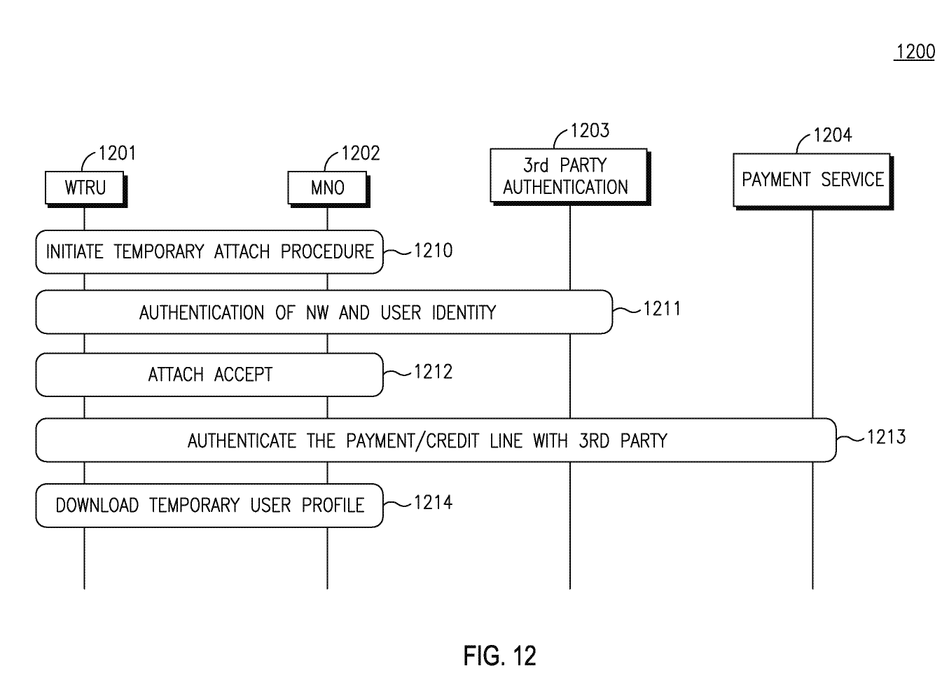

FIG. 12 shows an example of a control plane authentication procedure. The order for each step is for exemplary purposes, and no specific order is required. Authentication of both an MNO 1202 and the WTRU 1201 may be performed when a user requests services from an MNO 1202 to which the user does not have a subscription. The WTRU 1201 may authenticate the MNO 1202 in order to verify its credentials. The MNO 1202 may in turn authenticate the user for billing and security purpose. The WTRU 1201 may establish a connection with the MNO 1202 and initiate the attachment procedure 1210. During the attachment procedure 1210, (1) the WTRU 1201 may initiate the attachment procedure indicating that the WTRU 1201 does not have a subscription with the MNO 1202 (for example, EPS Temporary Service Attach may be used); (2) in order to provide mutual authentication, the WTRU 1201 may also provide a list of third parties that the WTRU 1201 trusts to verify the MNO's 1202 identity; (3) additionally, the WTRU 1201 may include expected security, privacy, QoS, and other parameters in the request; and/or (4) the MNO 1202 may select a third party that it also trusts to proceed with mutual authentication. If there is no third party that trusted by both the WTRU 1201 and MNO 1202, the attachment request may be rejected.

The MNO 1202 may then connect to the third party authentication center 1203 to initiate authentication of the MNO and WTRU 1211. Authentication of the MNO and WTRU 1211 may include providing the MNO 1202 identity to the third party authentication center 1203; providing the WTRU 1201 identity to the third party authentication center 1203; sending certifications for the MNO to the third party authentication center 1203; providing challenge question answers to the third party authentication center 1203; and providing an encryption key. Authentication of the MNO and WTRU 1211 may also include the third party authentication center 1203 providing a certificate for itself, verifying that the MNO 1202 is able to satisfy the WTRU's 1201 requirements and provide a certification for the MNO 1202, and/or providing a challenge to the WTRU 1201. Furthermore, authentication of the MNO and WTRU 1211 may include: the MNO 1202 forwarding certificates and a challenge question to the WTRU 1201; the WTRU 1201 verifying the certificates for the MNO 1202 and the third party authentication center 1203; the WTRU 1201 answering the challenge questions; the WTRU 1201 calculating the encryption key by itself; and/or the MNO 1202 and WTRU 1201 beginning to encrypt and protect its SRBs

An attachment acceptance procedure may be performed 1212. In the attachment acceptance procedure 1212, the MNO 1202 may create default bearers and reconfigure the WTRU 1201. The MNO 1202 may send an attachment acceptance to the WTRU 1201. In the attachment acceptance message, which may be a new NAS message, the MNO 1202 may provide the WTRU 1201 with a list of payment methods, and/or a service agreement or a link to service agreement.

The payment from the WTRU 1201 to the MNO 1202 may then be authenticated with the third party 1213. During authentication of the payment 1213, the WTRU 1201 may include the selected payment type, its certificate for the payment type, and a certificate for digital signature for service agreement. The MNO 1202 may authenticate the payment with the payment service 1204 and may begin to charge for that service. If authentication fails, the MNO 1202 may detach/disconnect the user.

A temporary user profile may also be downloaded 1214. The WTRU 1201 may download the MNO 1202 profile and save it to its SIM/USIM. There may also be a lifetime associated with the profile, and the WTRU 1201 may revert to its original profile after the lifetime expires.

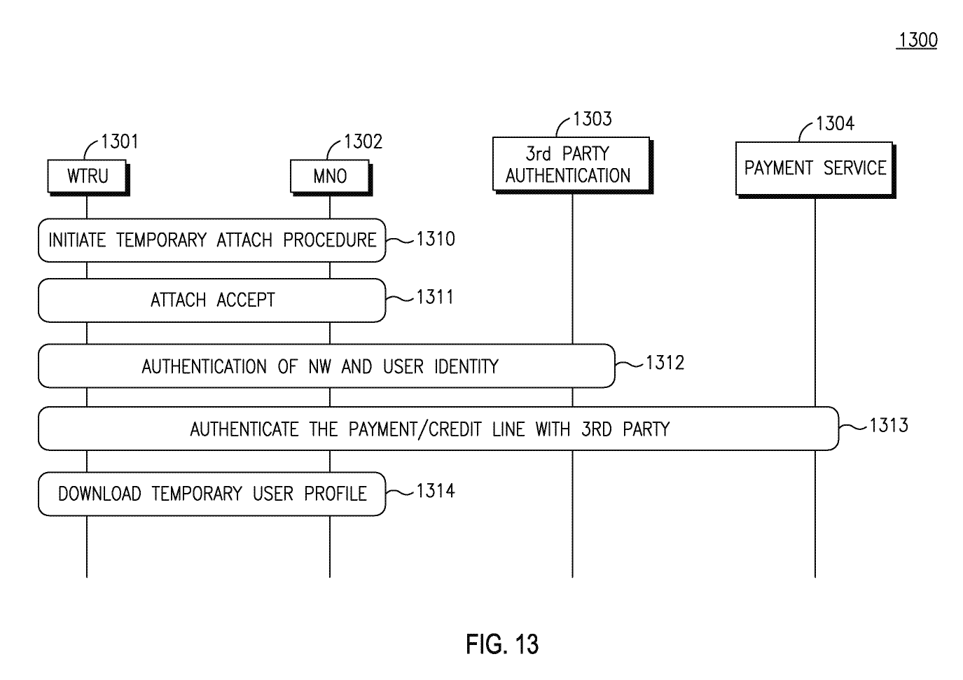

FIG. 13 shows an example of user plane authentication 1300. The order for each step is for exemplary purposes, and no specific order is required. Temporary attachment may be initiated 1310 by the WTRU 1301. During temporary attachment 1310, (1) the WTRU 1310 may initiate the attachment procedure indicating that the WTRU does not have a subscription with the MNO 1302 (for example, EPS Temporary Service Attach may be used); (2) in order to provide mutual authentication, the WTRU 1301 may also provide a list of third parties that the WTRU 1301 trusts to verify the MNO's 1302 identity; 3) additionally, the WTRU 1301 may include expected security, privacy, QoS, and other parameters in the request; and/or (4) the MNO 1302 may select a third party that it also trusts to proceed with mutual authentication. If there is no third party that trusted by both the WTRU 1301 and MNO 1302, the attach request may be rejected.

An attachment acceptance procedure may be performed 1311. In the attachment acceptance procedure 1311, the MNO 1302 may create default bearers and reconfigure the WTRU 1301. The MNO 1302 may also limit the services accessible by the WTRU 1301 (which may include but are not limited to identifying the third party authentication center and the payment center). The MNO 1302 may send an attachment acceptance to the WTRU 1301 that includes the selected authentication center 1303.

Authentication of the MNO 1302 and WTRU 1301 may then be performed 1312. The MNO 1302 may ask the third party authentication center 1303 to verify that the MNO 1302 is capable of satisfying the WTRU's 1301 requirements, provide a certification, and send the encryption and integrity keys to the third party authentication center 1303. The MNO 1302 may also forward certificates to the WTRU 1301. The WTRU 1301 may then establish a secure connection to the third party authentication center 1303 by requesting that the third party authentication center 1303 authenticate itself, authenticate the WTRU 1301, provide a certificate, and/or provide the encryption and integrity keys. The WTRU 1301 may then provide the certificate to the MNO 1302. Once authentication is complete, the MNO 1302 and WTRU 1301 may start protecting the SRB/DRBs with encryption/integrity.

The payment from the WTRU 1301 to the MNO 1302 may then be authenticated with the third party 1313. The MNO 1303 may redirect the WTRU 1301 to the payment verification process and provide the WTRU 1301 with a list of payment types. The WTRU 1301 may select one of the payment types. The MNO 1302 may then authenticate the payment with the selected payment service 1304. If authentication fails, the MNO 1302 may detach/disconnect the user. If authentication is a success, the MNO 1302 may alert other network components, including but not limited to the MME, SGW and PGW to remove the WTRU 1301 from the limited service state. The PGW or other network nodes may contact the PCRF regarding the charging policy and begin charging for the service.

A temporary user profile may also be downloaded 1314. The WTRU 1301 may download the MNO 1302 profile and save it to its SIM/USIM. There could also be a lifetime associated with the profile, and the WTRU 1201 revert to its original profile after the lifetime expires.

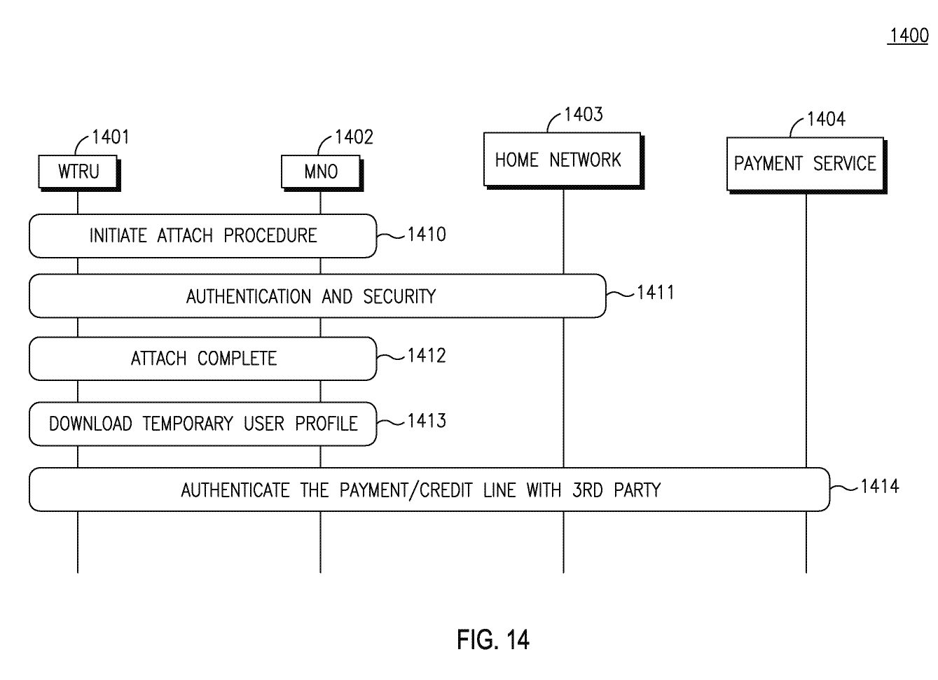

FIG. 14 shows an example of home network-assisted authentication 1400. The order for each step is for exemplary purposes, and no specific order is required. The WTRU 1401 may initiate the attachment procedure by indicating to the MNO 1402 that it does not want to continue roaming and that it wants to temporarily subscribe to a service from the MNO 1402 directly. The MNO 1402 may then put the WTRU 1401 into a limited service state.

Authentication 1411 may be performed by the MNO 1402 and/or WTRU 1401 according to any of the methods known in the art or described herein.

An attachment acceptance procedure may be performed 1412. After Authentication 1411, the MNO 1402 may provide a temporary IMSI and/or Mobile Station International Subscriber Directory Number (MSISDN) for the WTRU 1401 to use. The MNO 1402 may include the information in an Attach Accept message. The MNO 1402 may update its HSS with the WTRU's 1401 temporary IMSI and MSISDN number. The HSS may build a mapping between the WTRU's 1401 real IMSI and temporary IMSI and real MSISDN number and temporary MSISDN number.

A temporary user profile may also be downloaded 1413. The WTRU 1401 may download the MNO 1402 profile and save it to its SIM/USIM. There could also be a lifetime associated with the profile, and the WTRU 1401 revert to its original profile after the lifetime expires.

The payment from the WTRU 1401 to the MNO 1402 may then be authenticated with the third party 1414. The MNO 1403 may redirect the WTRU 1401 to the payment verification process and provide the WTRU 1401 with a list of payment types. The WTRU 1401 may select one of the payment types. The MNO 1402 may then authenticate the payment with the selected payment service 1404. If authentication fails, the MNO 1402 may detach/disconnect the user. If authentication is a success, the MNO 1402 may alert other network components, including but not limited to the MME, SGW and PGW to remove the WTRU 1401 from the limited service state. The PGW or other network nodes may contact the PCRF regarding the charging policy and begin charging for the service.

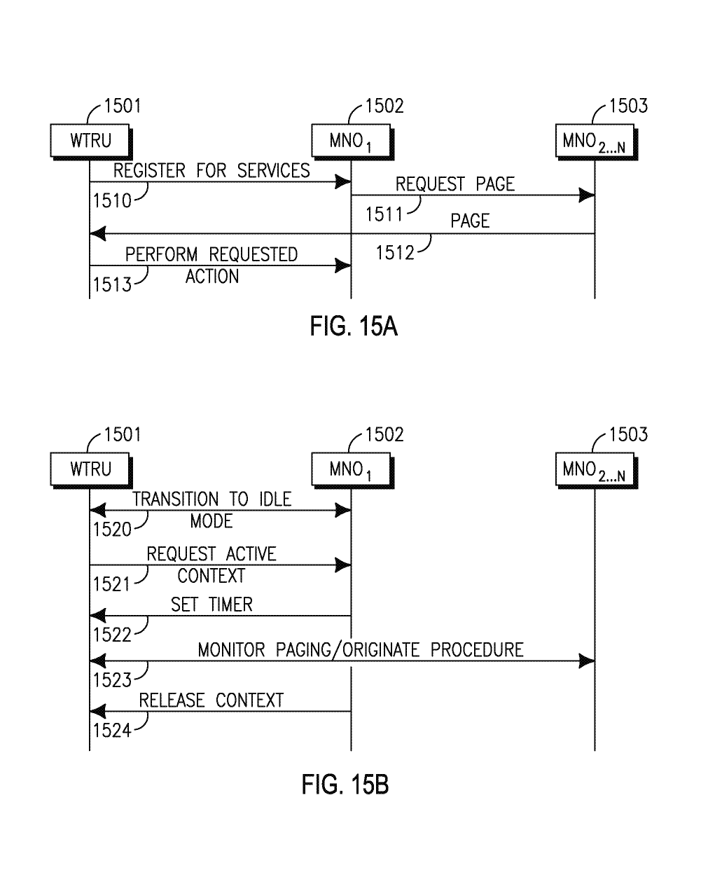

FIG. 15A shows a signal flow diagram of an out-of-network paging procedure 1500. A MOD WTRU 1501 registered for services 1510 on MNO₁ 1502 may experience limited coverage. As a result MNO₁ 1502 may request another MNO_{2 . . . n} 1503 to page the WTRU 1501 on its behalf. MNO_{2 . . . n} 1503 may then page WTRU 1501. Paging may be desired when the WTRU 1501 is idle on one MNO but may be connected to another MNO. For example, a WTRU 1501 may have a subscription for mobile originated (MO) calls on one MNO and mobile terminated (MT) calls one another MNO.

The WTRU 1501 may also be alerted of the need to be paged by MNO_{2 . . . n} 1503 in scenarios including but not limited to: network registration (for example ATTACH accept); during roaming updates (for example a TAU Accept); or during the connected mode session with the registered MNO₁ 1502 (for example by a NAS message or by a new RRC message). The WTRU 1501 may also be sent information with the RAT, frequency channel, cell identity (PSC/PCI), paging DRX length, and other scheduling information. The MNO_{2 . . . n} 1503 may provide the WTRU 1501 with a temporary profile for paging purposes.

The WTRU 1501 may take action according to the paging parameters received 1513. If the WTRU 1501 had moved out of the coverage of its connected MNO, MNO₁ 1502, it may send an attach request to the new MNO, MNO_{2 . . . n} 1503. This attach request may contain information that the WTRU 1501 was connected to MNO₁ 1502, which may then enable MNO_{2 . . . n} 1503 to retrieve the WTRU's 1501 context from MNO₁ 1502. Retrieving the WTRU's 1501 context from MNO₁ 1502 may enable the WTRU 1501 to have the same type of PDN connections and same IP address after attaching to MNO_{2 . . . n} 1503. The WTRU 1501 may also send a TAU request, which may trigger the MNO_{2 . . . n} 1503 to fetch the WTRU's 1501 context from MNO₁ 1502.

When MNO_{2 . . . n} 1503 pages the WTRU 1501 on behalf of MNO₁ 1502, the MNO_{2 . . . n} 1503 may provide in the paging messages, parameters including but not limited to a timer for the length of absence, the purpose of the page, and/or dedicated preamble information that the WTRU 1501 may use for fast re-entry back to this network. These parameters may have predefined values, which may be signaled for example by using a bitmap.

The WTRU 1501 may also have a capability to signal to MNO_{2 . . . n} 1503 a “callback later” indication, which may be associated with a configurable timer to establish the time for validity of the “callback later” indication.

If a MOD WTRU 1501 has registered with more than one LTE network MNO, the WTRU 1501 may choose to monitor paging messages from cells belonging to each of them. The WTRU 1501 may monitor either the “strongest” cell of a particular registered MNO based on measured signal power (RSRP) or the signal to noise ratio (RSRQ). The WTRU 1501 may also monitor a cell based on level of traffic. The WTRU 1501 may also monitor a tracking area (TA)/routing area for an MNO. Also, the WTRU 1501 may connect to one cell with a RRC Connection in an inactive DRX mode or in an active communication mode. The WTRU may choose to monitor other cells in its DRX mode inactive time or sleep time. The WTRU may optionally use its DRX on-duration time subframes only if the first n-subframes in the assigned on-duration period have not had any WTRU PDCCH assignments.

If in Connected State Active Mode with one MNO, the WTRU may empty slots in order to monitor other MNO's paging during the gaps. If a MOD WTRU is actively engaged in signals or data transfer with the network, the WTRU may use the subframe that has not been predicted for HARQ-transmission/reception of data and ACK/NACK for paging monitoring on other cells. If the WTRU determines there is not enough time for switching, the WTRU may ignore some of the data transfer subframes and switch to monitoring paging in other cells. The WTRU may make this determination based on priority.

Paging coordination between multiple MNOs may result in savings in battery life. When WTRU is a dual-SIM dual-standby (DSDS) WTRU and in idle mode monitoring paging from more than one cell, LTE paging coordination may be used to prevent paging frames or subframes from colliding or overlapping. Such coordination may include (1) round robin: the WTRU may monitor each cell one at a time; or (2) prioritized: the WTRU may monitor cells based on the priority of the MNO or services the WTRU is seeking.

Detection of a paging conflict is dependent on how far apart the subframes are and how fast the WTRU can switch between RATs, frequency bands, and cell specific coding such as scrambling or even the security codes associated with the PCI. If a paging conflict is detected, the WTRU may consider several factors in order to resolve the conflict. If the conflicts are infrequent such as when the paging-DRX-cycles are different, the WTRU may simply choose to monitor the paging in the cell and then revert to the prior coordinated order.

If the conflicts are frequent such as when the paging-DRX cycle and other parameters governing the timing of paging are the same, the WTRU may choose to monitor the paging in the cell that has the highest priority. Priority may depend on (1) whether the WTRU needs to notify the MNO of assignment changes including but not limited to the DRX-cycle-length or the offset, or the WTRU identity used for calculating paging scheduling; (2) whether the WTRU needs to notify the MNO regarding changing its DRX parameters which may be performed via the NAS ATTACH Request or the TAU message; (3) whether the WTRU needs to alter the coordination of monitoring based on the procedures described above; (4) whether the WTRU is registered more frequently or has more interaction with one of the MNOs.

System Information Broadcasting and System Information Reading may be performed by the WTRU, which may also save battery life. A MOD WTRU may read system information from a cell for purposes including but not limited to the following: (1) to read information related to the PLMN/Area/Cell when performing cell detection; and/or (2) to read the complete set of system information messages when the WTRU may access the cell for MNO access.

FIG. 15B shows a signal flow diagram of a MOD WTRU 1501 that may have subscribed to services with multiple MNOs, and therefore needs to coordinate interaction with the MNOs. The WTRU may temporarily transition to idle mode 1520 with respect to a first MNO₁ 1502 and request that MNO₁ 1502 keep the context active 1521 such that the WTRU may respond to paging from another MNO_{2 . . . n} 1503 or originate a NAS (EMM or SM) procedure 1524 on MNO_{2 . . . n} 1503. A timer may be set 1522 in the WTRU 1501 and/or in the MNO₁ 1502 to determine how long to maintain the context. The value of the timer may be provided to the WTRU in a RRC message or NAS (EMM or SM) message. After the timer expires, the WTRU 1501 and the MNO₁ 1502 may release the context 1524.

Before a transition to idle mode 1520, the WTRU 1501 may also provide an indication of a temporary absence to MNO₁ 1502 or negotiate with MNO₁ 1502 support for the absence. MNO₁ 1502 may then provide the WTRU 1501 a dedicated preamble (as an RRC message, for example) that the WTRU 1501 for use upon its return in order to acquire synchronization.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for use in a wireless transmit/receive unit (WTRU) for mobile network access without a prior subscription or service agreement, wherein the WTRU includes a virtual currency module (VCM), the method comprising:
requesting network access and services from at least one mobile network operator (MNO), wherein the MNO is selected from a plurality of MNOs;
supplying financial credentials from the VCM to the MNO; and
receiving requested network access from the MNO and services from the MNO following financial credential validation.

2. The method of claim 1, wherein the VCM is received from the MNO, the financial institution, a third party service provider (SP), or a manufacturer of the WTRU.

3. The method of claim 2, wherein the VCM is provisioned with a user's financial credentials and identity.

4. The method of claim 1, wherein the WTRU and MNO are mutually authenticated by a third-party authentication center.

5. The method of claim 1, wherein the MNO supplies the financial credentials received from the VCM to a second MNO, wherein the second MNO provides services to the WTRU as a surrogate.

6. The method of claim 1, wherein the MNO supplies the financial credentials received from the VCM to a second MNO, wherein the second MNO provides services to the WTRU when the WTRU is roaming.

7. The method of claim 1, wherein the WTRU registers with the MNO by sending a radio resource control (RRC) establishment cause, wherein the RRC establishment cause indicates support for multi operator access and a request for services.

8. The method of claim 7, wherein the WTRU requests network access by setting an information element (IE) in the RRC message to a value indicating a request for a universal public land mobile network/MNO.

9. The method of claim 1, wherein the MNO broadcasts support for multi-operator devices in a System Information Block (SIB).

10. The method of claim 1, wherein the WTRU monitors paging from a mobile network of an MNO through the mobile network of a second MNO.

11. A wireless transmit/receive unit (WTRU) that includes a virtual currency module (VCM), comprising:
memory configured for saving financial and subscriber credentials associated with the VCM;
a transmitter configured for requesting network access and services from at least one mobile network operator (MNO),wherein the MNO is selected from a plurality of MNOs, and further configured for supplying financial credentials from the VCM to the MNO; and
a receiver configured for receiving requested network access from the MNO and services from the MNO following financial credential validation.

12. The WTRU of claim 11, wherein the VCM is received from the MNO, the financial institution, a third party service provider (SP), or a manufacturer of the WTRU.

13. The WTRU of claim 11, wherein the VCM is provisioned with a user's financial credentials and identity.

14. The WTRU of claim 11, wherein the WTRU and MNO are mutually authenticated by a third-party authentication center.

15. The WTRU of claim 11, wherein the WTRU registers with a first MNO, and wherein the first MNO supplies financial credentials to a second MNO, wherein the second MNO provides services to the WTRU as a surrogate.

16. The WTRU of claim 11, wherein the WTRU registers with a first MNO, and wherein the first MNO supplies financial credentials to a second MNO, wherein the second MNO provides services to the WTRU when roaming.

17. The WTRU of claim 11, wherein the WTRU registers with the MNO by sending a radio resource control (RRC) establishment cause, wherein the RRC establishment cause indicates support for multi operator access and a request for services.

18. The WTRU of claim 17, wherein the WTRU requests network access by setting an information element (IE) in the RRC message to a value indicating a request for a universal public land mobile network/MNO.

19. The WTRU of claim 11, wherein the MNO broadcasts support for multi-operator devices in a System Information Block (SIB).

20. The WTRU of claim 11, wherein the WTRU monitors paging from a mobile network of an MNO through the mobile network of a second MNO.
